(19) United States
(12) Patent Application Publication
(10) Pub. No.: US 2015/0294356 A1
(43) Pub. Date: Oct. 15, 2015

(54) ADVERTISEMENT GENERATION IN AN ICON-BASED SOCIAL NETWORK

(71) Applicant: John Devecka, Pleasanton, CA (US)

(72) Inventor: John Devecka, Pleasanton, CA (US)

(21) Appl. No.: 14/747,662

(22) Filed: Jun. 23, 2015

Related U.S. Application Data
(63) Continuation of application No. 13/471,158, filed on May 14, 2012.
(60) Provisional application No. 61/485,443, filed on May 12, 2011.
(60) Provisional application No. 61/548,499, filed on Oct. 18, 2011.
(60) Provisional application No. 61/588,552, filed on Jan. 19, 2012.

(51) Int. Cl. G06Q 30/02; G06Q 50/00

(52) U.S. Cl. CPC G06Q 30/0255; G06Q 50/01; G06Q 30/0273; G06Q 30/0269

(57) ABSTRACT

An icon-based interactive personal profile search and matching system configured within a social network platform. The icon profile system includes an advertising interface to receive, from an advertiser, targeting criteria associated with an branded icon selected by the advertiser to identify targeted users registered with the social network platform to receive a customized advertisement directly from the advertiser via a user profile within the social network platform. A set of targeted users are identified that had a previous computer-based interaction with the branded icon via the social network platform. The previous computer-based interaction with the branded icon is identified by the social network platform and stored in a data store of the social network platform. The icon profile system delivers the customized advertisement via a respective user interface associated with the set of targeted users.

### CROSS-REFERENCE TO RELATED APPLICATIONS

This application is a continuation of U.S. patent application Ser. No. 13/471,158, filed on May 14, 2012, titled “System and Method for an Interactive Mobile-Optimized Icon-Based Profile Display and Associated Social Network Functionality,” which in turn claims the benefit of U.S. Provisional Application No. 61/485,443, filed May 12, 2011, U.S. Provisional Application No. 61/548,499, filed Oct. 18, 2011, and U.S. Provisional Application No. 61/588,552, filed Jan. 19, 2012. U.S. patent application Ser. No. 13/471,158, U.S. Provisional Application No. 61/485,443, U.S. Provisional Application No. 61/548,499, and U.S. Provisional Application No. 61/588,552 are each hereby incorporated by reference herein in their entireties.

### TECHNICAL FIELD

Embodiments of the present disclosure relate to the field of social networking. More specifically, the present invention relates to a mobile device-optimized interactive icon-based personal profile with an associated search, matching and communication system for social network communities.

### BACKGROUND

Social networking applications have become an important aspect of many people's daily social life experience. Although conventional social networking applications are widely used, the functionality and usefulness of these applications are still very limited.

For example, as a large segment of society gets older and have families, re-locate, travel, establish careers, take on late-night work schedules, pursue academic degrees, etc., their individual social time and opportunity for new social outlets become highly limited. These limitations on an individual's “free time” and the loss of social and recreational activity results in a loss of community connections and information sharing relating to a hobby or interests. In many instances, due to these and other constraints, people are un-connected to their own community, and fail to form relationships with residents that live on their same street, where they work, at events, while traveling, at locations they visit, or anywhere in their current local community. In this regard, finding new friends to share in social and mutual activity based events is a time consuming processes, due to engrained social norms, current social network technology limitations and the inherent inefficient process associated with meeting and making new friends and associates who have similar interest, goals, lifestyle and hobbies.

In today's “modern” society, with vast available social network technologies, new friendships are still frequently formed because of basic serendipity, convenience, or proximity. However, these factors are unpredictable and are not likely to produce the best and most enjoyable relationships. For example, two neighbors walking out of the house at the same time and stopping to chat for the first time is not an effective or ideal way to increase your social network with highly compatible friends. Frequently, the aforementioned new relationship opportunities are not initiated by the two people first being introduced because of have identified common personal profile interests.

Many social network systems have attempted to help solve this problem. However, due to cultural norms, writing a public text profile to find friends is not generally socially acceptable in an online open forum. The information is considered very personal and it may appear that the user seeking new relationships does not have many existing friends. Reading and searching static text based personal profiles is also time consuming and cumbersome especially on mobile devices. Therefore, many websites offering a friend matching service do not capture or utilize a sufficient level of personal information to be an effective friend and activity match-making tool.

In addition, many conventional social networking applications are directed to managing an existing “friend” network. In such cases, a user's friend network tends to plateau soon after the user joins the network because users typically allow only existing friends to share information. In this regard, “friend” matches or connections are not typically “new friends” and are conducted one at a time and identified and controlled by the individual user.

As such, current social communication networks do not offer a simple, efficient and culturally acceptable profiling system or method for establishing a social network based on accurate profiling and effective public representation of a user and identifying multiple users based on the users' common interests. The severe limitations of traditional lengthy, unstructured, static and non-interactive text based profiles prohibit mass user adoption. Furthermore, in most conventional online and mobile social network environments, especially text and video chat rooms, social forums and social gaming networks, few personal facts or commonalities about other users are known beyond the associated screen name and/or profile picture, severely limiting the technology's potential usefulness. In addition, these social communication networks fail to generate new profile matches for a user. As such, these computer and mobile device-connected social search, matching and social network lacks an encompassing, efficient and effective user profile display methodology and system. Therefore, an important need exists in the art for a new ubiquitous user profiling method and system to vastly improve social searching and matching and social connectivity in social network environments and technologies, further configured to efficiently create, present, search, match, view, compare, and display personal profile information among its users.

### SUMMARY

A system and method are presented for enabling a user to create a customizable interactive icon-based user profile representing the user's personal information, attributes, interests, places, likes, and activities and utilize the icon-based user profile to connect with other users in various social network environments. In an embodiment, via an icon profile creator tool, the format and content of an icon-based user profile may be generated and customized based on one or more social network genres selected by a user. Exemplary social network genres may apply to all existing social network communities, according to embodiments of the present invention, including but are not limited to a location-based and/or local events social network genre, a mass and/or niche friend and/or activity-based social network genre, an establishing “new” friends and/or activities social network genre, a social gaming network, a vanity profile social network genre, and/or a video and/or text chat or video broadcast services social network genre, etc.).

According to an embodiment of the present invention, the interactive icon-based profile technology and social network system and method (also referred to herein as the “icon system”) is configured to maintain multiple icons (e.g., a library or pallet of icons), each representing a profile element or elements. The icon system is further configured to receive a selection of one or more icons from a user and generate a user profile for the user based on the selected icon(s).

In one or more embodiments of the present invention, the icon system provides additional customized and auto-generated compatibility results or user-to-user matching, and user to group matching based on icon compatibility, a location-based parameter or preference (e.g., an identified “zone” or geographic proximity relative to a selected location), and/or other matching criteria. As used herein, the term “zone” includes, without limitation, a defined geographic region, a user, a place (e.g. a park, event or college campus) or location (e.g., city, county, state) or a region defined by a certain radial distance from a given point (e.g., a 10 mile radius from point A). In an embodiment, a user's zone may represent a geographic region or radius based on the user's home, current location, or other specified location (e.g., a planned destination such as a travel location, hotel or a new residence).

In an embodiment, the icon system provides multiple users with a graphical user interface (or GUI) including a series of independently representative and functional profile icons further linked to aspects of the social network from which to select in generating an icon-based user profile. An icon may include, but is not limited to, an image, a picture, a video, animation, or other visual indicator representing a profile element. As used herein, a profile element is intended to include any personal expression, such as, for example, a personality trait, interest, hobby, skill, ambition, preference, taste, award, attribute, statistic, dislike, location, establishment, brand, certification, biographical data, personal characteristic, business-related characteristic, etc. that may be selected by a user for inclusion in the user's profile.

According to embodiments of the present invention, multiple icons having one or more common attributes may be maintained and grouped into one or more icon categories. Exemplary icon categories include, but are not limited to, a fantasy category, a gaming category, a community interest category, a pop culture media preference category, an events category, an entertainment category, a lifestyle category, an interests category, a fitness category, a profession category, an affiliation category, an education category, an athletics category, a hobbies category, etc. In generating a user profile, the user may navigate the icon system using the icon categories in order to identify the one or more icons to select for inclusion in his or her user profile.

In an embodiment, the icon system enables a user to customize each system or user created icon element. The icon system provides an icon creator tool enabling a user to associate one or more secondary descriptors with a selected icon(s) (i.e., an icon selected by a user for inclusion in the user's icon-based profile). A secondary descriptor may be any additional information linked or associated with an icon which is used to further define, promote, verify, customize, or describe a user's preferences and relationship with the underlying profile element associated with the icon. According to embodiments of the present invention, the secondary descriptor may be a “secondary” icon associated with a primary icon (e.g., a primary icon representing a “motorcycle rider” profile element may have associated therewith a secondary icon representing a “Harley Davidson rider”), a text-based description, a rating, or any other expression which enriches, augments, or expands the accuracy of the relationship and/or preferences a user has with a user-selected icon. In an embodiment, unlike previous profile technology, each icon element is independently functional, useful and descriptive within the user's profile and the functionality of the entire icon social network system.

In an embodiment, a user may identify one or more icons from his or her user profile as a priority icon or visually differentiate in some manner from less important profile elements. The one or more priority icons selected by a user may be organized into a “billboard” or “highlighted” icon representing the most important profile elements associated with the user at that moment in time. These priorities may easily be viewed and changed, unlike standard text profiles constructed around associated sentences. For example, a user having a user profile including fifty icons may select eight icons as priority icons (i.e., profile elements which are most representative or best define the user) and include those eight icons in the user's billboard. In an embodiment, a user's billboard may be the top-level display (e.g., initially displayed by the system when encountering a user) associated with the user.

According to embodiments of the present invention, each of the multiple icons maintained by the icon system may have a unique identifier (ID) and may be linked to search terms, tags, keywords, associations, selected secondary descriptors, and/or user tags for use in search, commonality and compatibility determinations, overall matching of users of the system according to various system and user selectable matching methodologies. Furthermore, the system may match a user's icon identifiers against a database of other users with similar profiles and provide statistically based recommendations of activities, groups and other profile elements that the user may want to try.

Advantageously, the independently functional and informative, icons and profile elements create a completely interactive icon-based user profile. The user profile creation and publishing method of the present invention achieves socially acceptable, concise, consistent and vast info graphical presentation of a user and his or her profile especially on touch based mobile devices with small displays. Accordingly, embodiments of the present invention also overcome time and social constraints and barriers associated with conventional virtual and real-life social networking. The icon system allows users to efficiently identify, form and maintain a connection via online social communities based on the user's own profile elements and the icon system. As a result, the system enables new in-person connection opportunities and capabilities among otherwise, unknown and un-connected users having highly compatible profiles (e.g., similar interests, social schedules, proximity, etc.). New features and functionality are introduced into existing social network genres and technologies which utilize the icon profile display system and data to mutually notify, virtually connect and introduce compatible users in those environments.

According to embodiments of the present invention, a user's icon-based profile may be integrated and/or transported for use in other system-defined or third party environments. For example, a user profile may be employed (e.g., used to represent a user) in one or more of an environment focused on meeting new people; an icon-specific community (e.g., a “horseback riding” community including other users sharing a common interest in horseback riding); a clique or group of users matched based on a similarity of their respective user profiles, establishing a social calendar, and/or an external web service, social network community genre or social network technology, or environment (collectively referred to as an “external environment”). Exemplary external environments in which the icon-based user profile may be used to represent a user include, but are not limited to, a video and/or media broadcasting community, an event- based network, a travel and/or leisure web service, a social gaming network, a video and/or text chat platform, a retail and/or user marketplace. In this regard, the icon-based user profile and other aspects of the icon system represent a transportable profile with matching, virtual compatibility introductions and other functionality that may be used to connect and represent a user in any number of other social network contexts and environments to improve the existing social network technology and experience.

In embodiments of the present invention, the icon system may be configured to allow businesses, individuals and advertisers to promote goods and/or services to users, groups or icon communities. In an embodiment, advertisements and/or promotions may be directed to users of the icon system based on a user's data such as their icon profile elements, user site and activity usage history, brand preferences, test and survey data, acceptance of ads and services, specific profile elements, geography, secondary icon preferences cliques, events, groups, etc. Advantageously, advertising efficacy and mutual user and advertiser benefits are realized by the icon system since a user's icon profile represents user-specified, highly specific personal data regarding the user's profile elements (e.g., interests, activities, preferences, etc.).

In additional embodiments, computing devices for performing the operations of the above described embodiments are also implemented. Additionally, in embodiments of the invention, a computer readable storage media stores methods for performing the operations of the embodiments described in the present application.

### BRIEF DESCRIPTION OF THE DRAWINGS

The present disclosure will be understood more fully from the detailed description given below and from the accompanying drawings of various embodiments of the disclosure.

FIG. 1 illustrates an exemplary arrangement of associated icons maintained by the icon system, according to embodiments of the present invention;

FIG. 1A illustrates an exemplary arrangement of a primary icon and associated secondary icons, according to embodiments of the present invention;

FIG. 2 is a diagrammatic representation of a workflow illustrating an exemplary genre-based icon profile creation process, according to embodiments of the present invention;

FIG. 3 illustrates exemplary interface of an icon-based social network system displaying an icon-based user profile associated with a first user including exemplary secondary descriptors, according to embodiments of the present invention;

FIG. 4 illustrates an exemplary interface of a mobile device application of an icon-based social network system, according to embodiments of the present invention;

FIG. 5 illustrates an exemplary process flow for generating an icon- based user profile, according to embodiments of the present invention;

FIG. 6 illustrates an exemplary interface of an icon-based social network system displaying an icon profile creation tool, according to embodiments of the present invention;

FIG. 7 illustrates an exemplary process flow for generating a customized icon-based user profile including secondary preferences according to embodiments of the present invention;

FIG. 8 illustrates an exemplary interface of an icon-based social network system displaying secondary descriptors associated with an icon, according to embodiments of the present invention;

FIG. 9 illustrates an exemplary interface of an icon-based social network system displaying an exemplary user-generated icon process, according to embodiments of the present invention;

FIG. 10 illustrates an exemplary interface of an icon-based social network system displaying an exemplary “smart clique” compatibility and matching user group creator tool, according to embodiments of the present invention;

FIG. 11 illustrates an exemplary process flow for searching within an icon-based social network system, according to embodiments of the present invention;

FIG. 12 illustrates an exemplary interface of an icon-based social network system displaying exemplary search results returned by the icon-based social network system in response to a user search, according to embodiments of the present invention;

FIG. 13 illustrates an exemplary interface of an icon-based social network system displaying an exemplary icon-based community or clique, according to embodiments of the present invention;

FIG. 14 illustrates an exemplary interface of an icon-based social network system displaying exemplary search results returned by the icon-based social network system in response to a search including secondary descriptor criteria, according to embodiments of the present invention;

FIG. 15 illustrates an exemplary interface of an icon-based social network system displaying an exemplary icon-based calendar, according to embodiments of the present invention;

FIG. 16 illustrates an exemplary interface of an icon-based social network system displaying an exemplary invitation and chat associated with an icon calendar event, according to embodiments of the present invention;

FIG. 17 illustrates an exemplary process flow for an icon-based user profile system in multiple social network environments, according to embodiments of the present invention;

FIG. 18 illustrates an exemplary interface of an icon-based social network system displaying an exemplary icon-based social community environment, according to embodiments of the present invention;

FIG. 19 illustrates an exemplary interface of an icon-based social network system displaying an exemplary icon-based video chat, text chat, and broadcast social community environment, according to embodiments of the present invention;

FIG. 20 illustrates an exemplary interface of an icon-based social network system displaying an exemplary social gaming community environment, according to embodiments of the present invention;

FIG. 21 illustrates an exemplary process flow for creating and/or delivering a concierge service or advertisement in the icon-based social network system, according to embodiments of the present invention;

FIG. 22 illustrates an exemplary interface of an icon-based social network system displaying an exemplary icon-based advertisement creation and delivery tool, according to embodiments of the present invention;

FIG. 23 illustrates an exemplary interface of an icon-based social network system displaying an exemplary zone-based advertising delivery tool, according to embodiments of the present invention; and

FIG. 24 illustrates is a block diagram of an exemplary computer system that may perform one or more of the operations described herein.

### DETAILED DESCRIPTION

An interactive icon-based profile and associated social networking system (or “icon system”) configured to provide an info graphic of personal information consisting of a series of independently actionable icon elements further independently layered with user personalization and functionality within the icon user search and social community environment. The icon system provides an efficient, effective, and enjoyable social network platform for multiple users wishing to find, meet and share with others with mutual commonality. The icon system may be configured in various ways, including, for example, as a stand-alone web site or application with multiple social community genre categories or within existing social network programs, blogs, video chats, social gaming communities, other sites, or communities to quickly and efficiently promote personal attribute commonalities and awareness between unknown users, increase peer to peer communication and identification and most importantly provide new functions and features afforded by this new icon system and its data.. The icon system uses icons to greatly enhance profile reading efficiency, user communication and network growth, such as via an API interface or by direct integration of a customized icon profile software module.

A user may create or have a user profile created for them including multiple icons (i.e., an icon-based user profile). Each icon represents a profile element and may be actionable to permit connection, peer communication, formation of communities, calendar based activity, content sharing, invitations, and dialog associated with the profile element underlying the icon.

According to embodiments of the present invention, the icon system includes one or more computing devices configured to perform the steps, functions, actions, features, processes, communications, activities, etc. described throughout the present application. In embodiments of the present invention, the one or more computing devices configured to implement the icon system may operate within a single computing device (e.g., a server) or on multiple computing devices.

The icon system may comprise any number of computer components (e.g., computer-implemented instructions, programs, scripts, etc.) implemented together in a single device or networked in various combinations of multiple different devices that operate together. Examples of a computing device that may be configured to implement the icon-based social network include, but are not limited to, a server, a mainframe computer, a networked computer, a process-based device, and similar type of systems and devices. The network may include the Internet in one embodiment. In other embodiments, other networks, wired and wireless, such as an intranet, local area network (LAN), wide area network (WAN), or broadcast network may be used.

The icon system and its associated computing platform are configured to communicate with multiple users operating a suitable user device via a suitable network. The user device may be any type of computing device, for example, any data processing device, such as a desktop computer, a laptop computer, a mainframe computer, a personal digital assistant, a server, a handheld device, or any other device able to process data configured to execute one or more software programs configured to perform one or more functions, a device including a processing device (e.g., a processor), a computer-readable medium, and a memory. In some embodiments, the user device may be executing a browser application or other application adapted to communicate over Internet related protocols (e.g., TCP/IP and HTTP) and/or display a user interface.

In an embodiment, the icon system may include a client operating on the user devices which is configured to communicate with a server to perform the functionality described in detail in connection with the Figures of the present application. For example, the icon-based social network system may be implemented by having a client application on a mobile device associated with the user, wherein the client application is configured to communicate with one or more remote computers (e.g., one or more servers) via a network.

In an embodiment, the icon system includes and/or is associated with a database (herein the “icon database”) configured to store the multiple icon profiles and instructions associated with the processes performed by the icon system. The icon database may include any computer readable storage medium. The term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, optical media, and magnetic media. Other alternate mobile efficient technology may be integrated and utilized in conjunction with the described invention to multitask, improve site navigation, purchases and search commands and the like, which may be voice activated and controlled by mobile applications.

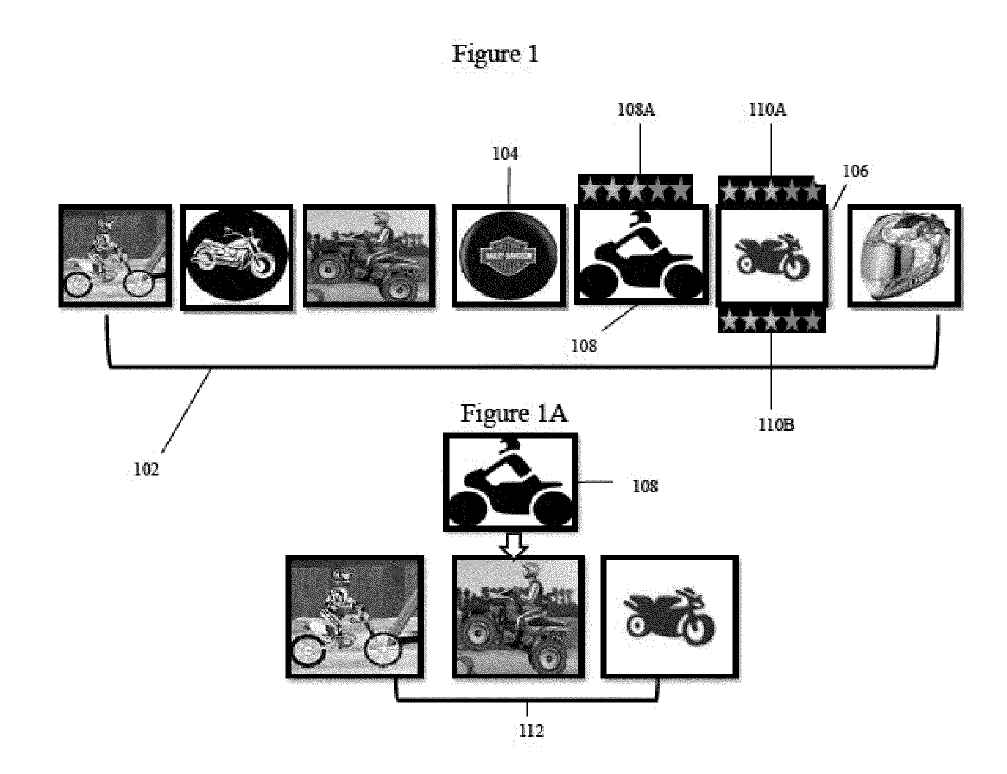

FIG. 1 illustrates an exemplary selection of system associated icons maintained by the icon system, according to embodiments of the present invention. In FIG. 1, an icon bank 102, or a collection of category-related icons is shown. The exemplary icons in the icon bank 102 provide examples of the vast and highly specific communication properties of the system-selected icon images within a category for use with the icon system. As shown, the exemplary icons provide and communicate important and instant compatibility information relative to a type of profile element (e.g., a particular activity or interest), without the presentation of text header descriptors. Construction by the system or use of the available icons may contain visual properties to distinguish subgroup or sect preferences and differences which may be linked to the category and sect search terms.

The example icon bank 102 includes seven icon images relating to motorcycles as a hobby. Each icon represents a different subcategory or sect having an established and instantly familiar meaning to those having an interest in the category associated with the icon bank 102 (in this case, motorcycles). For example, use of a generic or nondescript motorcycle or less specific icon image may provide a less accurate or incorrect assessment of compatibility and may cause a negative result for a social connection, chat or associated joint activity. However, selecting a broader and generic category icon may be utilized to also increase the number of match results and potential contacts.

For example, a first user selecting icon 104 for inclusion in his/her user profile and a second user selecting icon 106 for inclusion in his/her user profile have both indicated an interest in motorcycle riding, however, they are not necessarily compatible for riding together. The first user selecting icon 104 rides Harley-Davidson™ motorcycle while the second user selecting icon rides a racing motorcycle. Matching hobby sects accurately may be important to compatibility in some cases.

As shown in FIG. 1, via an icon preference and personalization creator tool, a user is able to indicate a skill level associated with the icon, such as, for example, using the skill level indicator banner 108, 110. The skill level associated with an icon represents a basic secondary descriptor which may be used by the icon system and user in determining compatibility among users. For example, a first user indicating a skill level 110A associated with icon 110 may not be compatible with a second user indicating a skill level 108A associated with icon 108 even if they both ride fast high speed motorcycles if the first user strictly enjoys riding with other expert level riders they may not be compatible to ride together.

In another example, a user selecting icon 104 rides a cruiser and may not be able to handle the speed and roads that a user selecting icon 108 typically enjoys. However, if the user selecting icon 104 cannot find another cruiser rider to ride with, he or she may still consider connecting with the user selecting icon 108 knowing they will both have to compromise on the terrain and speed. In this regard, the icon profile and matching system allow users of the icon system to make their own assessments of an acceptable match based on a consideration of the icons and secondary data associated with another user's icon profile element.

As shown in FIG. 1, another secondary descriptor that may be associated with an icon is a passion level indicator 110B. A user may indicate his or her passion level associated with a profile element represented by an icon using, for example, the passion level indicator banner 110B shown in FIG. 1. The passion level may be used as a secondary descriptor and a further basis for identifying and determining matches among users of the icon system. These secondary system descriptor selection options may be standardized or customized by the system for different icon profile element types.

FIG. 1A illustrates an exemplary icon 108 representing a general characteristic of the underlying profile element (e.g., a generic motorcycle rider icon). A user may select icon 108, or select a pop up text based secondary descriptor to indicate that the user is open to any style of riding which would generate more matches and attract more invitations to ride. In an embodiment, a generic icon, such as icon 108, may also be associated with a subcategory 112 of icons which further define particular profile elements related to the top level or generic category icon 108 that a user may include in his or her user profile. In embodiments, creating a subcategory 112 may clarify, define or refine a user's preferences or capabilities, such as, for example, indicating a favorite motorcycle brand, link to other related media (e.g., videos, images), or link to user's blog, past and future activity, calendar, user rating, earned badges, certifications, and posting history relating to the profile element. In an embodiment, some or all of the secondary descriptor information and data may be used as one or more tags or keywords to be used broadly within the system but as an example, in search and matching algorithms, described below in greater detail.

In embodiments of the present invention, a secondary descriptor indicator may be associated with an icon (e.g., 108) or icon element type, to indicate further information regarding a user's relationship with an icon and its underlying profile element. For example, icon 108 may have associated therewith an indicator such as symbol or an “F” for fan, “G” for general interest, “I” inactive, “M” for mentor or “C” for collector (not shown), or other like secondary descriptors. Secondary descriptors allow accurate refinement, consistent representation and statistical data of an otherwise generic user icon profile element. In some cases, secondary descriptors may be prominently displayed on the main profile page view with the icon profile element.

As shown in FIGS. 1 and 1A, the icon system is configured to provide richly detailed and/or layered animated icon-like images with revealing secondary descriptors and secondary or subcategory icons and associated information relating to a profile element (e.g., a hobby or other category) which communicates further details relating to preferences and attributes. This body of information may be used by the icon system to enable a user to more accurately and precisely select or identify other users and their preferred matches quickly, without reading and searching a user's text profile in which much of this information is typically absent. In embodiments, the icons and associated secondary descriptors may be considered in generating and enhancing the accuracy of search results, advertising, matches, groupings, and online forums.

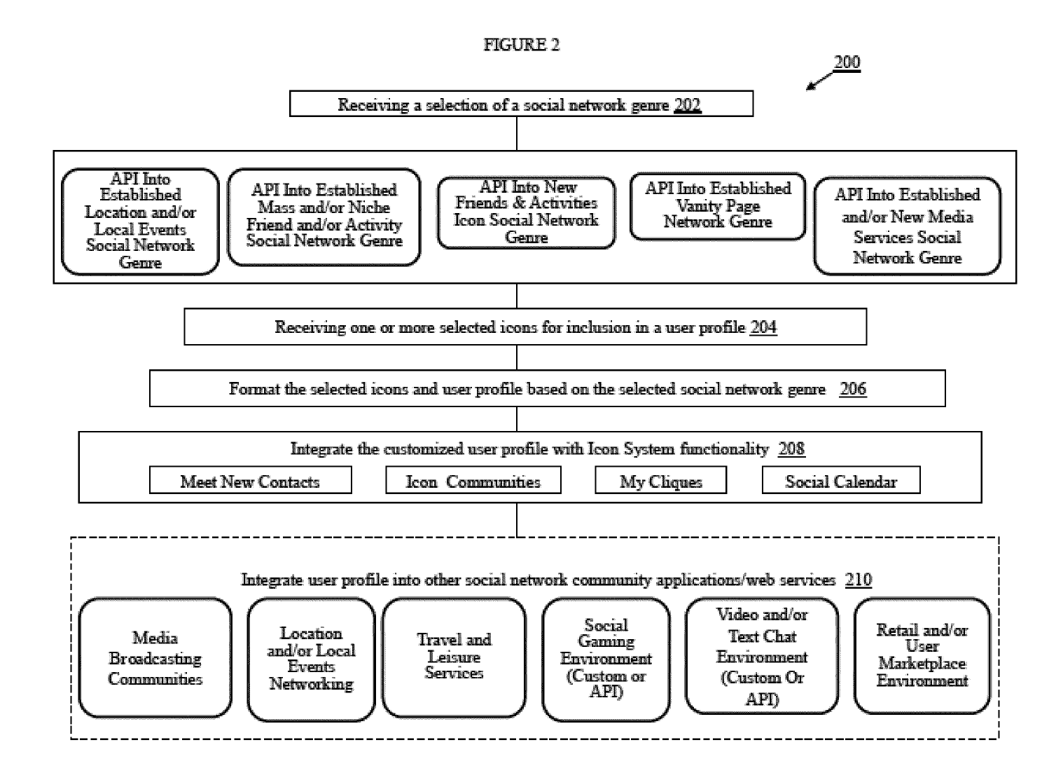

FIG. 2 illustrates a workflow illustrating an exemplary genre-based user profile creation process 200, according to embodiments of the present invention. As shown in FIG. 2, in method 200, a user may interact with the icon system in order to create a user profile using a social network genre provided by the icon system. In block 202, a selection of a social network genre is received by the icon system. A social network genre may be any community demographic target, area or use associated with social networking which may be used as a guide for the user in establishing a user profile within the icon system. In embodiments, the social network genre type may provide a framework and target community or social network technology within which the user may create a user profile, and have any number of setup screens or steps that are associated with, related to, or customized for a particular genre type. Exemplary genre types may include, but are not limited to, a location and/or local events social network genre, an established and/or niche friend and/or activity social network genre, a new friends and/or activity social network genre, social gaming network, an established and/or new vanity page social network genre, and an established and/or new media services (e.g., video chat, text chat, video broadcast services) social network genre. One having ordinary skill in the art will appreciate that in addition to the examples described herein and shown in FIG. 2, other genre types may be employed in connection with embodiments of the present invention. According to embodiments of the present invention, the icon system provides a user identification system that is applicable to any connected social community or technology.

In embodiments of the present invention, based on the selection of the social network genre received from a user in block 202, an appropriate portal (e.g., application programming interface (API)) may be employed which guides the user through one or more steps relating to the creation of a user profile or the system may offer fully integrated social network genre systems and portals. In an embodiment, the user profile steps may be genre-specific such that the particular genre selected by the user informs the user profile setup workflow (e.g., the types of information and manner of presentation of screens, fields, prompts, icons, etc. presented to the user during the user profile creation process).

In block 204, the icon system receives one or more selected icons for inclusion in the user profile. In an embodiment, the icons may be selected by a user from a genre-specific pallet or library of icons. In block 206, the icon system formats the selected icons and the user profile based on user preferences, secondary data and the selected social network genre and associated technology environments available. In an embodiment, based on the selected genre, particular formatting and/or customizing may be performed with respect to the icons and/or user profile. For example, if a user selects the established and/or new media services social network genre, the associated user profile may be formatted to include information relating to the user's mobile device limitations, bandwidth capabilities, existing media-related accounts (e.g., existing video/chat room account information), etc. In an embodiment, in block 206, the icon system may receive secondary descriptor information from the user to customize the selected icons included in the user profile.

In block 208, the icon system integrates the customized user profile with one or more functional areas of the icon system (i.e., the icon system functionality) for use of the user profile within the various functional areas. Exemplary main system functions and social networking categories of the icon system, shown in FIG. 2, include, but are not limited to, “meet new contacts” functionality, “icon communities” functionality, “my cliques” functionality, and/or “social calendar” functionality. It is noted that various additional areas of functionality are included within these categories and other overall the icon system, and that the examples shown in FIG. 2 are for illustration purposes.

Optionally, in block 210, the icon system may integrate the customized icon profile system with other environments including controlled and external social network community applications, technologies and/or web services. The optional nature of block 210 is represented in FIG. 2 by a dashed line. The other social network community applications and/or web services may include third party environments, applications, programs, and/or web services, such as, for example, third party travel websites/applications, third party social networking websites/applications, third party retail websites/applications, etc. Exemplary functional areas of the icon system, shown in FIG. 2, include, but are not limited to, media broadcasting communities, location and/or local events networking, travel and leisure services, social gaming (e.g., custom or API-based), video and/or text chat environments (e.g., custom or API-based), and/or retail and/or user-based marketplace environments. Since the icon profile and system offers many novel user identification and online social improvements in online social communities, the system is potentially applicable for integration into all online social environments and technologies.

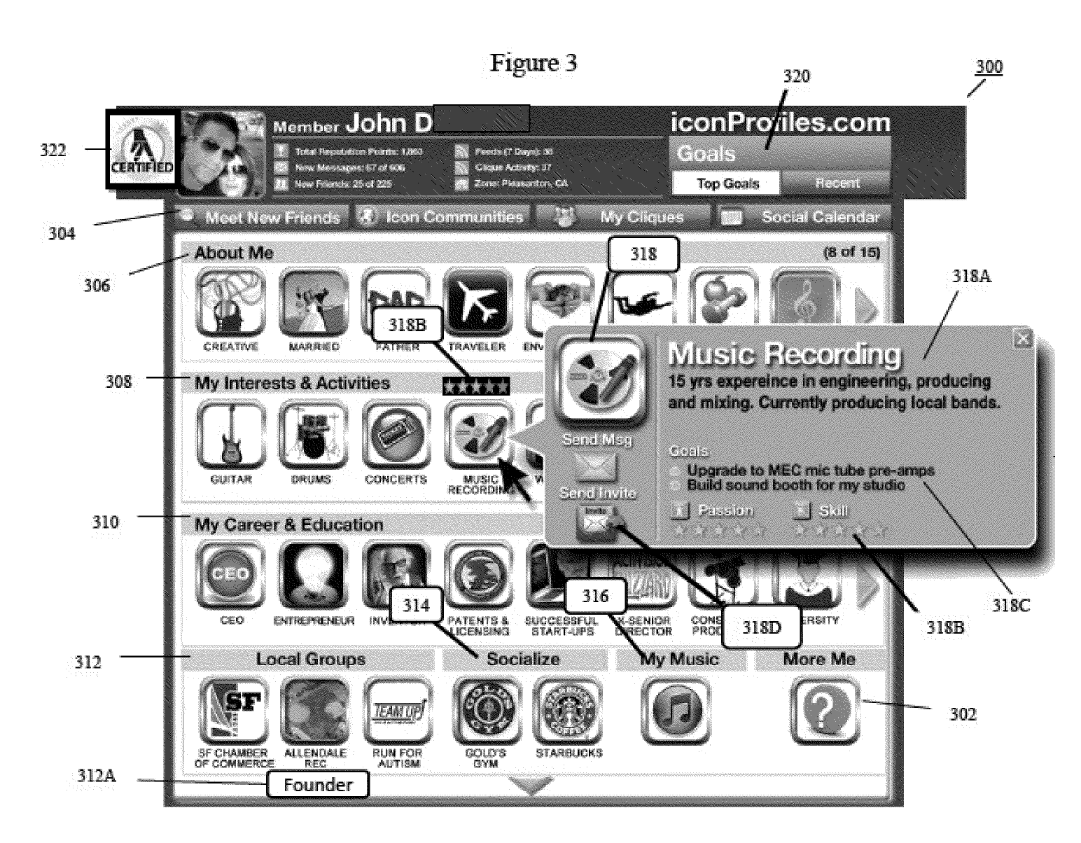

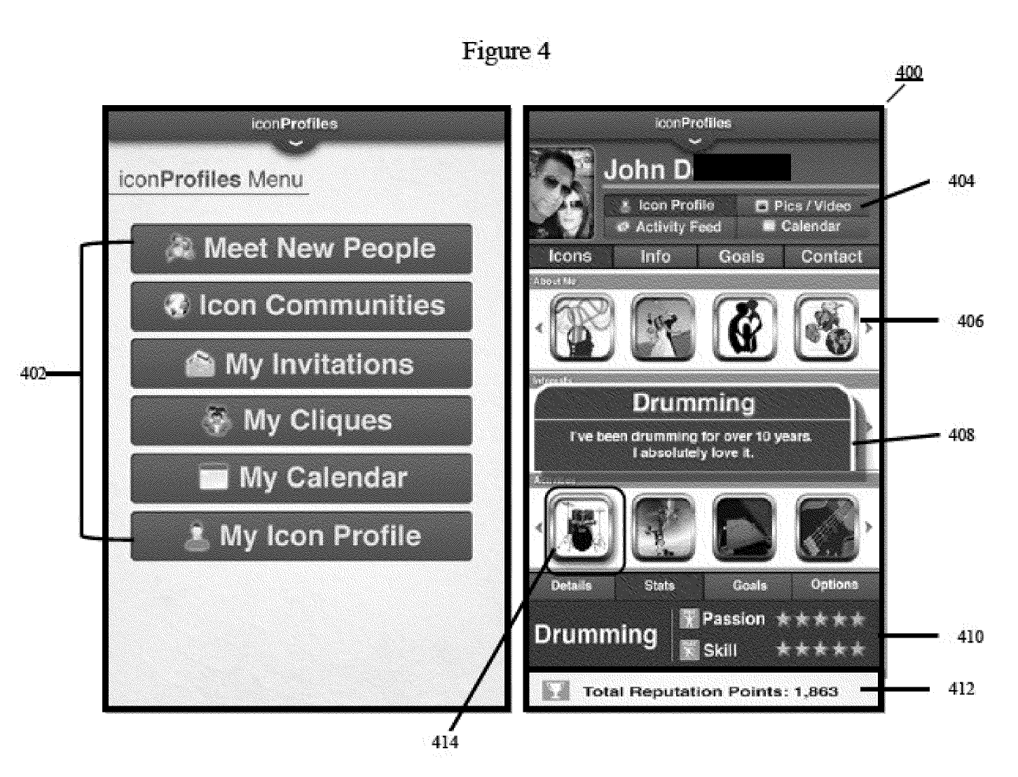

FIG. 3 illustrates exemplary interface of an icon-based social network system displaying an icon-based user profile 300 associated with a first user (i.e., “John D”) including exemplary secondary descriptors shown in a pop up or revealing display, according to embodiments of the present invention. The exemplary user profile 300 may be formatted to operate and be displayed via the icon system on a mobile phone (as shown in FIG. 4), a mobile tablet or other computing device, according embodiments of the present invention. Each icon of the user profile 300 may be interacted with (e.g., touched in a touch-screen environment or interacted with a point device (e.g., a mouse and associated pointer) or with voice activation in order to perform an action associated with the selected icon (e.g., obtain additional information about an icon).

As shown in FIG. 3, the user profile 300 may include an image (e.g., an actual picture or avatar) identifying the user associated with the user profile 300. It is to be appreciated that for privacy reasons, a user may elect to use an avatar or partially revealed profile display instead of an actual photograph. In an embodiment, the user may create an avatar that resembles the user for their public user profile. This privacy feature is useful when rejecting offers for friendship and encourages more users to join and set up profiles.

In yet another embodiment, the icon system may be configured to only use avatar or no profile pictures in a public version of a user profile (i.e., a version of the user profile that is accessible by any user of the icon system). In an embodiment, a private user profile (i.e., a user profile accessible only by other user who are connected or linked to the user) may include a user's actual profile picture and may be revealed with authorization after a connection is accepted or if a person is linked to a user's friend. This allows all users to experience match results with other user profiles maintained in the icon database, but only reveal his or her identify (e.g., real name, contact information and/or picture) to other users that he or she accepts or connects with. In an embodiment, a user may request participation of another person in the icon system by sending email invitations derived from their email contacts or friend lists and related data available from other sites or email accounts. In an embodiment, a user's imported friends, which are indentified and indicated as such in the system, may be immediately categorized in contact or icon activity groups (e.g., one or more “Icon Communities” or “My Cliques” shown in FIG. 3) and icon compatibility may be determined and reported. In an embodiment, imported contacts may be automatically highlighted and linked to a priority status position in the user's features, social communities, search results and/or other suites in the icon system as later described. In some cases, users may discover new interests of their current friends and realize an ‘actual’ compatibility ranking with those existing friends using the icon system. Active users or other selected mutually compatible users may also receive priority based features, notifications, mutual public community identification, virtual introduction encouragements, community recognition, status and perks compared to less active users of the site and users who are less compatible.

In an embodiment, a user may also determine compatibility shared traits and participate in communities with a larger group, location, or different community or alternately selected zone based on elements in their user profile. These compatibility trends may be posted to the members of a given community (e.g., a geographic community or an icon-based community). Under certain settings, when a user has accepted another user for an activity, users may share typical narrative personality profiles or join a mutual video chat provided by the system, whereby the other user is able to learn more about their new potential friend or group prior to or instead of an initial meeting. In an embodiment, a privacy setting may be controlled by the user with respect to any data and/or icons in the user's profile to enable the user to control which information/icons are displayed publicly (i.e., as part of the user's public profile).

In an embodiment, some information and preferences may be utilized by the icon system to determine compatibility without explicitly stating or presenting every realized compatibility element. Some personal information, survey and test result icons, other selected icons and data may be viewed by the user in an inactive page or folder. Some icon elements may not have associated social communities or secondary characteristics. This data may be displayed and used in the icon system based on the user's preference requirements. In an embodiment, a narrative may be composed automatically for the user based on icon data or partially derived from a personality profile test administered by the system or selected by the user, by usage, or icon profile data, and may be accessed via an icon such as the “More Me” icon 302.

For example, a text description generated by the icon system associated with a user named Rich may include “Rich is married, in the legal field, with 2 boys, Johnny and Jake under 8 years. Rich likes all outdoor activities and is very competitive and athletic. He takes his favorite activities very seriously and strives for perfection. He is a straight shooter and will do anything for his close friends. Rich's 5 favorite activities are: Weight training, Basketball, Playing Guitar, Running & Surfing. He is typically free on Sunday early in the morning. Check out his calendar openings and join or invite him for your next adventure.” Other “More Me” icon 302 content may include any other profile categories, associations, elements and associated secondary elements that are deemed less important or superfluous by the user.

According to an embodiment of the present invention, the initial setting for a user profile may filter compatibility determinations or the user may select to only participate in the site functions and activities with users of the same sex. In this embodiment, the same-sex filter tailors the icon system service to the legitimate intent of making new “friends”, as compared to romantic connections. In other embodiments, user profiles may be configured for unisex compatibility determinations, and/or have the ability to view opposite sex profiles or have an avatar picture displayed for opposite sex viewers.

As shown in FIG. 3, the user profile 300 is integrated with various features, functionality and environments 304 (e.g. a “Meet New Friends” environment, an “Icon Communities” environment, a “My Cliques” environment, and a “Social Calendar” environment). A user may access these environments 304 from his or her user profile, and use his or her user profile and associated icon system functionally in those respective environments 304. In an example, the “Meet New Friends” environment may include various searching and matching features. In another example, the “Icon Communities” environment may include all the available internal and external API social network technologies and genres. In a further example, the “My Cliques” environment may include user categorization methods, user commonality determination method options and a communication system for these categorizations of matched search results. Social Calendar includes an icon based social calendar which is fully integrated with icon profile elements, an invitation system, notifications, and an events management system.

As shown in FIG. 3, the user profile 300 may include multiple icon categories or groups, offered by the system or customized by the user targeted for a social network genre, for example, the “About Me” icon category 306, the “My Interests & Activities” icon category 308, the “My Career & Education” icon category 310, the “Local Groups” icon category 312, and the “Socialize” icon category 314. It is noted that the user profile may include any number of icon categories, profile display and format options, profile pages, and sub pages and each icon category may include any number of icons as desired by the user creating the user profile.

In an embodiment, the “About Me” icon category may include icons representing a range of personal information and characteristics potentially not related to a particular interest and/or activity, such as, for example, the general area where a user lives, their relationship status, personality traits, preferences for music, movies, books and causes that they are passionate. The most important icon elements of any category may be presented in importance ranked order or they may simply be highlighted as such or display a secondary descriptor for any profile category.

As shown in FIG. 3, the user profile 300 may include an exemplary icon section or grouping relating to basic information about the user (i.e., the “About Me” section 306). The About Me section 306 may include icons relating to a user's basic information such as marital status and other top level interests. Some or all public profile icons may have user-selected information or functionality that is restricted for privacy purposes, which includes blocking secondary information from being revealed, even if the icon system utilized that information for determining compatibility. The user profile 300 may also include an exemplary icon section or grouping 308 relating to the user's prioritized profile elements (e.g., interests and/or activities). A viewer of this full profile may automatically be presented with visual indicators programmed to highlight mutually matching, similar or related icons and perhaps the degree or identified relationship for each highlighted icon as determined by the icon system.

The user profile 300 may also include an exemplary icon section or grouping relating to the user's career and/or education background (i.e., the “My Career & Education” section 310), which may be used to present business related interests, skills and experiences. In addition, the user profile 300 may include an exemplary icon section or grouping 312 including icons associated with one or more local icon groups with which the user has created, founded or is a member. An exemplary icon section or grouping 314 including one or more icons associated with one or more locations that the user typically socializes (e.g., the “Socialize” icon category 314), and an exemplary icon section or grouping 316 including an icon associated with the user's music preferences. In an embodiment, a user may store and prioritize location icons for frequent activity meeting places. The structure and look of icon profiles, categories and icons may be customized by the user. An array of indicators may be displayed in association with each icon in a profile to inform the searcher of the user's preferences, status, events, activity and the like to enhance the efficiency of the icon system. In another embodiment, an integrated, pictorial collage-like image profile is used as a profile page. Endless options exist for profile formatting and content in an actionable icon form.

In an embodiment, the “Socialize” icon category 314 may be configured to represent a grouping of favorite places a user likes to eat, drink or frequent for activities. While at these locations, users of the system may “check in” and meet other system users who are present at that same time. These icons may also linked to a map and/or social calendar, in order to quickly arrange a meeting place for someone or one of their group activities, as an example.

In an embodiment, a “My Store” icon category (not shown) may be provided in the user profile and provide a portal to an environment wherein the user may offer to sell, buy, recycle or promote personal items and services (potentially for a fee) which may be viewed on the user profile page, with an associated icon element, or in a related icon community feed tagged within a user's selected zone. In an embodiment, seller ratings may be provided along with online payment or bidding systems. In an embodiment, users may benefit from having access to a dedicated icon online marketplace to buy and sell items and services relating to specific profile elements (i.e., particular passions, activities, and interests). These features and services may also be associated with a concierge account, as described below. These icon aggregated communities of experts and enthusiasts provide a specialized and optimized buying and selling market.

In an embodiment, the secondary descriptor information for an icon and/or icon group may include a measure of the level of the user's participation, past and future events, and status in that group as well as other tools such as group statistics, pictures, media, member information, or join feature and further information.

In an embodiment, a user's status and position as a “founder” 312A of a local group may be displayed in the user profile. According to an embodiment of the present invention, a founder of a new icon group has the ability to control and administer some of the information, secondary icon pop up information, invitation functions, group purpose and mantra, number and sex of members, media, news, advertising and posts for that group or control all sub group or local chapter formations.

In an embodiment, the user profile 300 may also include a section relating to one or more goals 320 established by the user. Under a “goals” category 320, a user may display an interest in pursuing a hobby or aspiration that he or she has not achieved yet, is a onetime event or is a novice in this area. For example, two users with the same interest and same overall goals for that interest are identified as highly compatible. An indicator may be configured to differentiate the icon as a goal, thereby indicating that the user has not attempted that activity or is a novice. The “goals” category 320 may also attract other users who have the same ambition or allow users of a concierge service (described below) or advertisers to find users or groups who may want specific instruction, offers, news, information or services to help them reach an icon displayed goal. A user goal status feed and status summary may also be displayed allowing another user quicker access to all or a portion of a user's posted and accomplished goals and recent scheduled activities from their profile. In an embodiment, users may be matched and searched based on their goals associated with an icon and other secondary information.

In embodiments of the present invention, any of the icons in the user profile 300 may be independently interacted with, used for contact, searching, social communities, social technologies such as social gaming and video chat and broadcasting, invitations or calendar events, or selected by the users of the icon system in order to input and/or review additional information associated with the selected icon (i.e., the secondary descriptors). For example, as shown in FIG. 3, user profile includes a music recordings icon included in the “My Interests & Activities” section of the user profile 300.

By selecting the music recordings icon, a pop up window 318 or revealing action is generated and allows the viewer to review secondary descriptors and further tertiary media and information related to that icon set by the user which are associated with the music recording icon. For example, the music recording icon and associated pop up window 318 or revealing animation may communicate multiple secondary descriptors and pages including, for example, a text-based description 318A, a skill level indication 318B, and a goals indication 318C. In an embodiment, any of the secondary descriptors may also be displayed in connection with the icon as it appears on the main user profile display. For example, the music recording icon is associated with a level indicator 318B (including a passion level and a skill level) which is visible from the main user profile display, without requiring a pop up or other window to display the secondary descriptor information. The pop up window 318 also allows other users to contact the user to inquire about engaging in that icon activity with the user, using, for example, the “send invite” icon 318D linked to the icon social calendar or request to a user to attend a blog community, video or text chat session based on that subject inquiry.

In an embodiment, secondary descriptors that may be associated with an icon may include, for example, a voice recording, animation, music file, text box, picture, link, badge, ranking, rating or video. In an embodiment, the pop up window 318 may appear above an associated icon, in a designated area on the display or an animation may appear (e.g., an animation wherein the icon appears to flip over), or in a text box on the screen with a user's desired action or more descriptive icons appearing along with an actionable pallet of user contacting methods, communication messages, system related actions, or other suitable tools that relate to that icon element type In an embodiment, the viewer may control what level of detailed information he or she wishes to view by selecting a user's icons. The icon system may also report where a user currently is present within the social community system.

In an embodiment, the user's customized selection of icons for inclusion in his or her user profile and any associated secondary descriptors may be associated with an icon search term for use in determining a user's desired specificity for compatibility. For example, a less specific icon within a category may result in a broader compatibility outcome (e.g., results in a greater number of matches) as compared to a highly specific icon and secondary descriptors including a zone preference.

The described additional skill, passion and/or preference detail may remain “covered” unless the viewer touches or otherwise interacts with a top-level icon. In an embodiment, presenting the secondary descriptor information in a convenient manner dramatically shortens the time a user spends evaluating a user profile and determining compatibility. For example, a user may request to view matches or only show results based on certain key secondary descriptors (i.e., use the secondary descriptors as a filter). The resulting sorting or consolidation process may be user-driven or performed by the icon system in order to provide consistent profiles and results for all users and device types.

In an embodiment, a user may post icon-sized pictures, images or videos regarding a specific icon or group, under a main icon element to provide more specific information. For example, a user may display an “ET” icon as a favorite movie on their user profile. Highlighting that brand registered icon may display the user's favorite clip, play a sound file of “ET' s” voice, or display scenes from that movie or the presentation may be provided by paid advertiser of the “ET” movie icon and offer a link to purchase the movie. In this same method, brands and advertisers may potentially embed exclusive secondary content with their associated icon element. Further examples include a community group icon for “ET” memorabilia buying and selling. One having ordinary skill in the art will appreciate that additional embodiments may be employed for formatting, stacking, organizing, linking and displaying secondary descriptor information.

In an embodiment, the user profile 300 may be certified, as indicated by the “certified” designation 322. A user and his or her associated user profile may be certified to demonstrate that the user profile is authentic and represents the underlying user with which the profile is associated by any suitable method known in the art (e.g., via an algorithm check of independent information used to authenticate the identity of a user, other user ratings, badges, and recommendations, by charging a fee to obtain certified status, etc.). The “Certified” designation may also be an indicator that the user has been rated highly by several different members who know the user or have scheduled an activity with the user and reported positive interactions.

According to embodiments of the present invention, the user profile (e.g., user profile 300 in FIG. 3) may be used by the icon system to determine compatibility of the user associated with the user profile 300 with other user profiles maintained by the icon system. In embodiments, many traditional and interpretive methods of compatibility may be selected by a user or the icon system's matching algorithms. Embodiments of the present invention include, but are not limited to, system or user-selected preset and customizable match algorithms including interpretations, theories, random or other derived assumptions of compatibility compared to direct icon compatibility such as having a matching Icon and skill level requirement. In addition, matching criteria may be derived from the community practices or based on norms within that community. An icon system or user-selectable compatibility option wheel or menu may be offered that contains traditional and less traditional profile matching customized for the social community, such as, for example, astrology, personality traits, business theory, social standing, surveys, tests, games, lifestyle, psychology, ideology, hobby and interest personality traits, complimentary opposing compatibility, team compatibility, interest category hierarchy matching, fantasy, games and other measures based off usage, and or icon or use profile selections.

According to an embodiment of the present invention, the skill level indicator (e.g., 318C in FIG. 3) is displayed in order to allow viewers further clarity on compatibly based on their unique preference. For example, two musicians with a large variance in skill or music genre style might not be interested in playing together despite having a common passion for music. In this example, a “guitar” icon associated with a text-based description box, media file, or other indicia indicating the user is a “blues player” may be displayed to more narrowly describe a preference or skill In another example, the user may have an icon of Eric Clapton, a noted blues player, with further related media, such as an MP3 file or YouTube video link including an offer to purchase the featured song from an advertiser.

In an embodiment, the icons included in a user profile may be categorized or marked as an “active” “priority” or a “past” interest or hobby. A past interest or inactive indicator may infer the person's skills are probably lacking or they are not very interested in participating in that hobby currently at that point in time. Unlike static text profiles, users will frequently change these categories and priorities due to travel, changing seasons, or simply because they have a new preference. This information may be used to increase compatibility with another user if the interaction is based on an activity. Frequency indicators (e.g., how often or frequently a user participates in an activity) may also be provided in the first level (e.g., a top level or initial display of a user profile) of an icon or user profile view or a second level of the icon or user profile view (e.g., following an interaction with the top-level icon). For example, an expansion of an icon associated with an activity may include second descriptors such as a next available date or typical date-related and intensity preference for participating in the activity.

In an embodiment, a passion level indicator may also be associated with an icon as a user may be passionate but lack skill or experience. In operation, after selecting an icon for inclusion in the user profile, a user may select a status identifier such as “Fan” or “Follow” in place of a skill rating, and also provide an indication of how passionate they are as a fan or follower. In an embodiment, a fan or follow indicator is associated with the icon to differentiate it from a user who is an active player or participant in the underlying profile element. In embodiments, fans or followers may be searched for by players and invited to events and enjoy the icon group community and news feeds configured for ‘fans’ or for the general icon. For example, a football fan would typically watch football with friends, debate team and player skills, and go to football events. In comparison, an active football player may be more interested in playing the sport and staying fit. In some cases, a user may have a secondary descriptor indicating that he or she is both a fan and a player. In an embodiment, users may search profiles based on their preference for a certain skill, intensity preference or passion level for an activity which may be communicated via an icon, primary page indicators and a secondary descriptor.

FIG. 4 illustrates exemplary interfaces of a mobile device application of the icon system, according to embodiments of the present invention. As shown in FIG. 4, an exemplary user profile 400 may be customized a smaller display on a mobile device including basic icon system functionality 402 and a toolbar 404 for video chat, media sharing and the like. As previously discussed, the icon categories 406 offer an easy-to-read, informative, and independently actionable profile overview with efficient attribute viewing capabilities compared to current lengthy, static and non interactive or integrated text-based profile information for any social group genre and associated technology.

In an embodiment, as shown in FIG. 4, the exemplary user profile screen 400 includes a drumming icon 414 which is actionable to display second descriptors, communities, searching, and contact means or methods (i.e., a contact connection) associated with the icon 414. In this example, a secondary descriptor including a text-based description 408 of the user's drumming experience is displayed. In addition, various statistics associated with the drumming icon 414 are displayed, including a passion level indication and a skill level indication 410 and an earned “total reputation points” score 412 (e.g., a statistical assessment of the user's reputation or expertise level relative to a profile element which may be calculated and/or determined based on various information collected and maintained by the icon system).

For example, using a touch screen device and a mobile application associated with the icon system, the user may gesture swipe in the area of 406 to easily view additional icons in that category. According to an embodiment of the present invention, the first page or first icons are chosen as the most important to the user, or have been most utilized as determined by the system as the most skilled or passionate interests. Other icon profile lists or pages may be created, managed and customized by a user for participation via the icon profile system or via API's with different sites and communities.

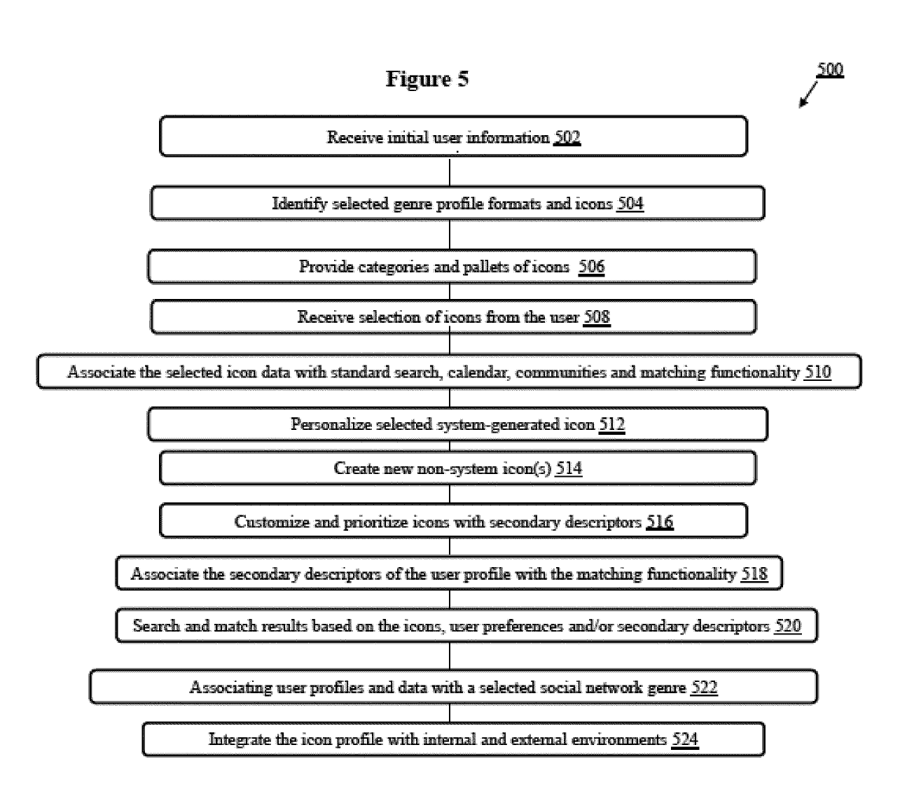

FIG. 5 illustrates an exemplary method 500 for generating an icon-based user profile, according to embodiments of the present invention. As shown in FIG. 5, method 500 includes receiving initial user information from a user, in block 502. The initial user information may include, but is not limited to, basic background information of the user (e.g., sign-up information such as a name, address, etc.), an indication of a social network genre (e.g., the genres described in connection with FIG. 2), and/or a selection of an icon profile creator system or functionality.

In block 504, the icon system identifies the user profile format and library or of icons associated with the selected genre, identified in block 502 (or a general format and library if no genre is selected/specified by the user). From the identified library of icons, a pallet of icons including icon categories is presented to the user, in block 506.

In block 508, the icon system receives from the user a selection of multiple icons from the pallet of icons for inclusion in the user profile. In an embodiment, the user may also be provided with profile category or format options, an optional icon or text based survey, game, test, content suggestion, or other guidance that may be used by the icon system to generate profile content and icon suggestions or suggestions regarding prioritization of selected icons for the user.

In block 510, the icon system associates, links, connects, relates, etc. the user profile including the icon data with one or more functional areas or environments of the icon system which are configured to use the user profile. For example, the one or more functional areas or environments may include, but are not limited to, the icon system's searching functionality, calendar functionality, social community categories, technologies and groups, and the compatibility/matching functionality.

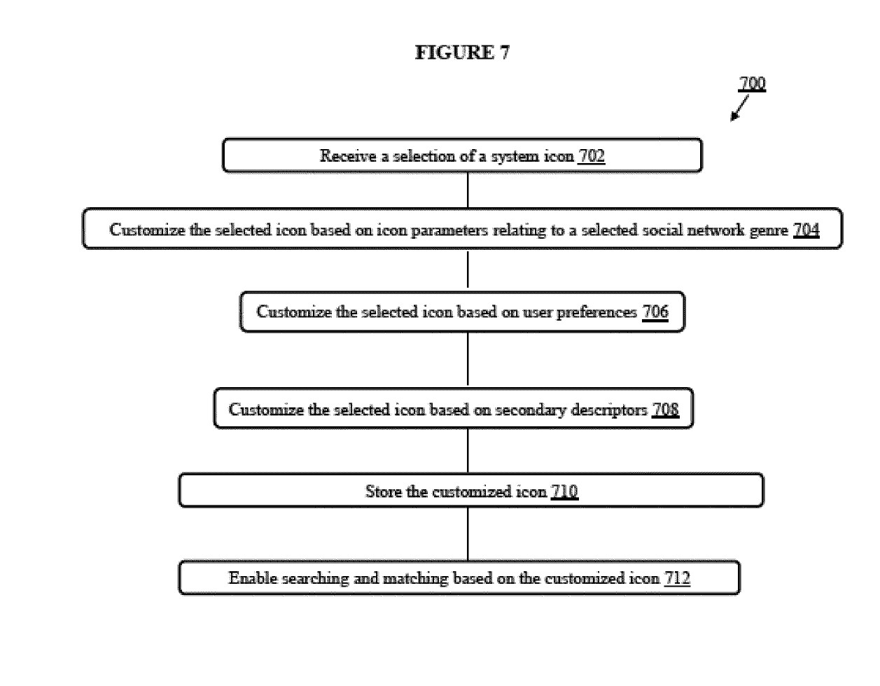

In an embodiment, in optional block 512, the icon system may customize and/or personalize a system-generated icon based on user preferences, information and/or parameters received from the user, as described in greater detail in connection with FIG. 7. For example, the user may personalize or upgrade the appearance or functionality of an icon according to his or her preferences. Brand and/or advertising-based icons may also be selected which the content may be partially provided and controlled by the advertiser. In block 512, the icon system may customize an icon or user profile in accordance with user-established preferences, such as, for example, privacy preferences, matching preferences, community preferences, calendar preferences, etc. In addition, the icon system formats the user profile and/or icons included in the user profile in accordance with the user preferences.

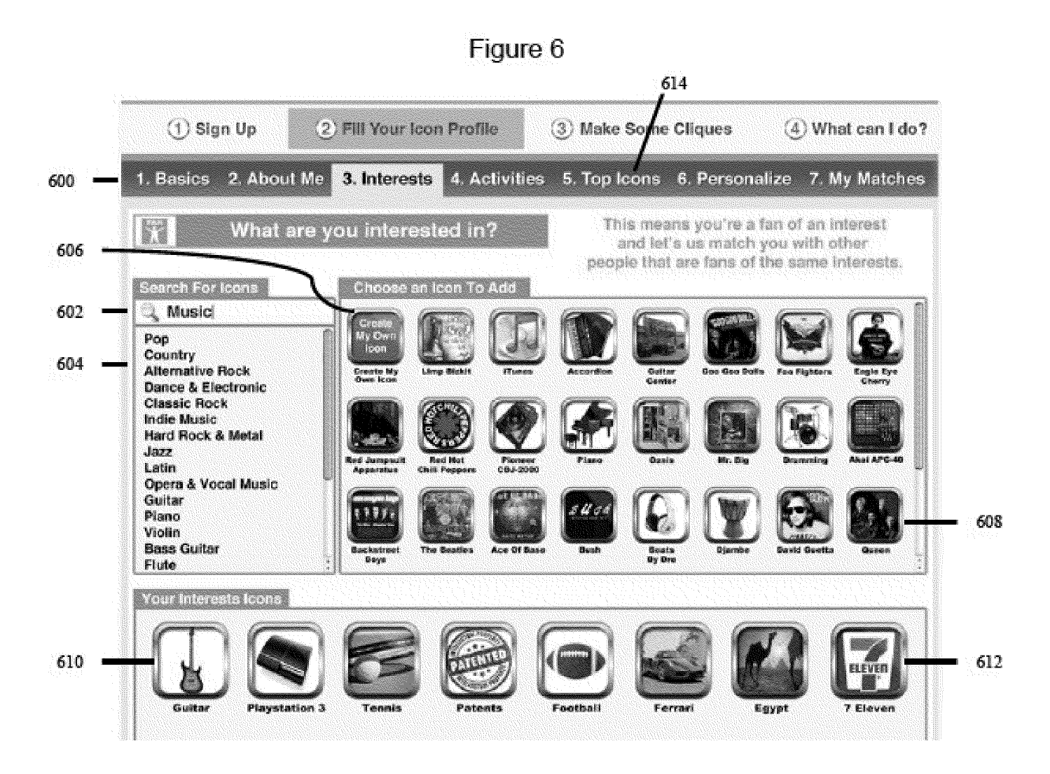

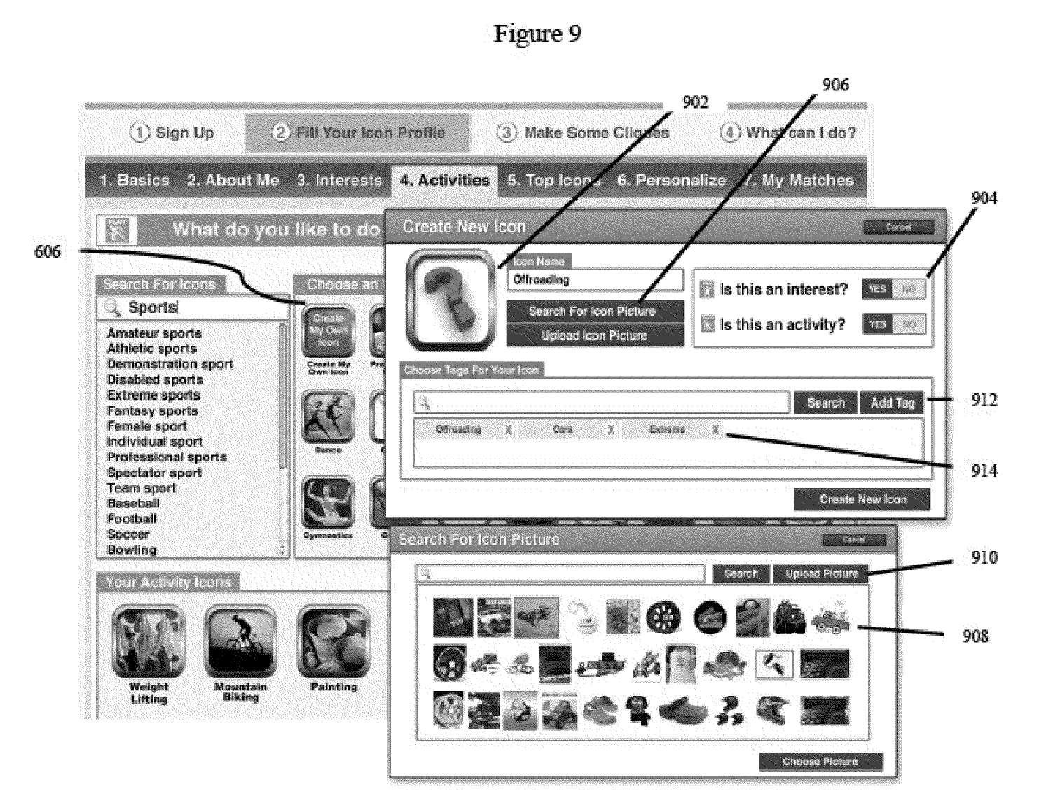

In an embodiment, in optional block 514, the icon system may create a new non-system icon (i.e., an icon not included in the initial library maintained by the icon system) based on information, preferences, and parameters received from the user, as described in greater detail below with respect to FIGS. 6 and 9.

In an embodiment, in block 516, the icon system customizes and prioritizes one or more of the selected icons in the user profile with secondary descriptors, as described in greater detail in connection with FIG. 7. According to this embodiment, in block 518, the secondary descriptor information associated with the user profile is stored and may be used in connection with the compatibility/matching functionality of the icon system.

As shown in block 520, the icon system is configured to search a database of user profiles and match a first user profile with other user profiles based on the icons of the first user profile, user preferences, overall compatibility and/or secondary descriptors associated with the user profile within the icon system.

In block 522, based on a user selection of one or more genres or social network technologies in block 502 or a later selection of a genre by the user, the user profile and associated data may be added to the selected social network genre system(s) or social network technologies for use therein.

In optional block 524, the user profile may be distributed or exported to an internal environment (i.e., an environment or subsystem of the icon system) or an external environment (i.e., an environment that is not maintained by the icon system) for integration with a third party social networking application or web services or for use in inviting other potential users to use the icon system.

FIG. 6 illustrates an exemplary interface of an icon-based social network system displaying an icon profile creation tool configured to perform the method 500 shown in FIG. 5, according to embodiments of the present invention. In an embodiment, after signing up by providing basic user data, account preferences and uploading a profile photo or video, the user is prompted to select icons based on the category headers 600 (e.g., icon categories such as “basics”, “about me”, “interests”, “activities”) and icons provided by icon system. In the example shown in FIG. 6, the user selects an interest in music or was suggested 602 and one of the genres listed in associated music genre list 604 is highlighted. A pallet of icons, each with a unique ID, possibly embedded with secondary media, linked to search terms, related icon elements, traits, associations, inferences keywords, and other tag matching data is presented to the user in display area 606.

If, for example, the user selects the band “Queen” icon 608, the Queen icon 608 appears in the “Your Interest Icons” display area and become part of the user profile along with any/all previously selected icons 610 and 612. The “Queen” icon may be an advertiser or branded icon containing other embedded content, offers, media, and functionality.

As shown, the pallet of icons in display area 606 includes an icon that may be used to create a new music-related icon under this genre that is not found in the system-generated list. If the user wishes to create an icon she will select the “Create My Own Icon” icon and open a new icon creator or group icon creator system based on the properties of the desired icon element, shown in FIG. 9.

According to embodiments of the present invention, the icon system may maintain a basic or framework icon structure for non-system-generated icons. IN this regard, the icon system may maintain a generic icon structure for use by a user in creating a custom icon. The framework or structure may include one or more fields adapted to receive information from the user during the custom icon generation process. For example, the icon structure may include fields relating to a visual field update, a name, a search term associated with the non-system (i.e., custom) icon profile element. In addition, once the custom icon is created based on the input from the user, the custom icon may be stored in a searchable database for display in the associated user's profile and/or in the icon database for use by other users when creating his or her own icon profile.

As illustrated in FIG. 9, in association with the pallet of icons 606, a pop up window 902 is displayed which allows the user to define a new user-generated icon. In an embodiment, the user may define parameters associated with the user-generated icon, such as an icon name, an icon type 904 (e.g., an activity and/or interest), and/or search for or select an image, animation or representation for the icon. Upon selection of the icon picture search button 906 icon, a pop up window may appear which includes a pallet of existing images 908 that may be used for the icon or enable a user to upload a different image 910 from various internal or external media devices, image databases, search sources and other related resources. In an embodiment, the user may use an “add tag” button 912 to add tags and/or keywords, or associate it with a system icon and the like 914 associated with the icon.

Returning to FIG. 6, in an embodiment, once the user has selected all of the interest and activity icons the user may rank and/or order their interests based on their preference using the “Top Icon” button 614 and related functionality of the icon system. In an embodiment, the user may establish the icon priority by dragging or highlighting his or her selected icons and placing them in a desired order. It is to be appreciated that the user may easily edit his or her user profile including the icon rankings as their ranking and/or other secondary preferences changes.

FIG. 7 illustrates exemplary method 700 relating to generating a customized icon-based user profile, according to embodiments of the present invention. One having ordinary skill in the art will appreciate that the blocks shown in FIG. 7 represent optional parameters, preferences, and/or information that may be received from the user and/or determined by the icon system for use in customizing one or more icons genres and/or a user profile.

In block 702, a selection of an icon is received by the icon system. The selected icon may be associated with icon information including, but not limited to, icon header display text, an icon identification number, a media element (e.g., an image or video), an indication of other associated icons, secondary preferences, and one or more searching and/or matching terms, tags, and/or keywords.

In block 704, if a social network genre has been selected, the icon system identifies any icon parameters (e.g., features, structure, format, requirements, etc.) for the selected icon based on the selected social network genre. The icon system then customizes the selected icon based on the genre-related icon parameters.

In block 706, the icon system receives user preferences provided by the user relating to customization of the icons for the user profile. Exemplary user preferences associated with individual icons and/or the user profile may include, but are not limited to, selecting a display preference when an icon is touched or selected, setting matching preferences including whether the user allows matching invitations, adding associated gear and/or gear preferences, automatic user-to-user matching, use icon for icon communities, profile privacy settings (e.g., identifying portions of a user profile for inclusion in a public profile and/or a private profile), preferences relating to the sharing of icon updates, and setting preferences with respect to concierge services and/or advertisements. It is to be appreciated that additional user preferences may be utilize to custom icons and/or user profiles in the icon system. One having ordinary skill in the art will appreciate that in certain instances, block 706 is optional, in that a user may not identify any user preferences for use in customizing the selected icon.

In block 708, the icon system receives one or more secondary descriptors associated with the selected icon. Exemplary secondary descriptors associated with various individual icon element types and/or the user profile may include, but are not limited to, a selection of a profile element type (e.g., a “fan”, “participant”, etc.), a selection of a level indicator (e.g., a passion level indicator, a skill level indicator, etc.), a “quick view” symbol or indicator for inclusion on a top level user profile page or display, a text-based icon description, active or inactive, select for use in icon social communities, one or more goals associated with the selected icon and whether those goals are displayed in a goals feed, adding a calendar association to the selected icon, indicating a frequency preference (e.g., active participant, former participant, retired participant, etc.), associating gear, equipment, brands with the selected icon, associating additional content (e.g., videos, links, applications, pictures, historical data, etc.) with the selected icon, and adjusting the placement and priority of the selected icon in the user profile. It is to be appreciated that additional secondary descriptors may be utilized to customize icons and/or user profiles in the icon system. One having ordinary skill in the art will appreciate that in certain instances, block 708 is optional, in that a user may not identify any user preferences for use in customizing the selected icon.

In block 710, the customized icon is stored in the icon database and the searching and matching functionality is or may be enabled based on the customized icon (e.g., the customized icon may be used for searching and matching purposes), in block 712.

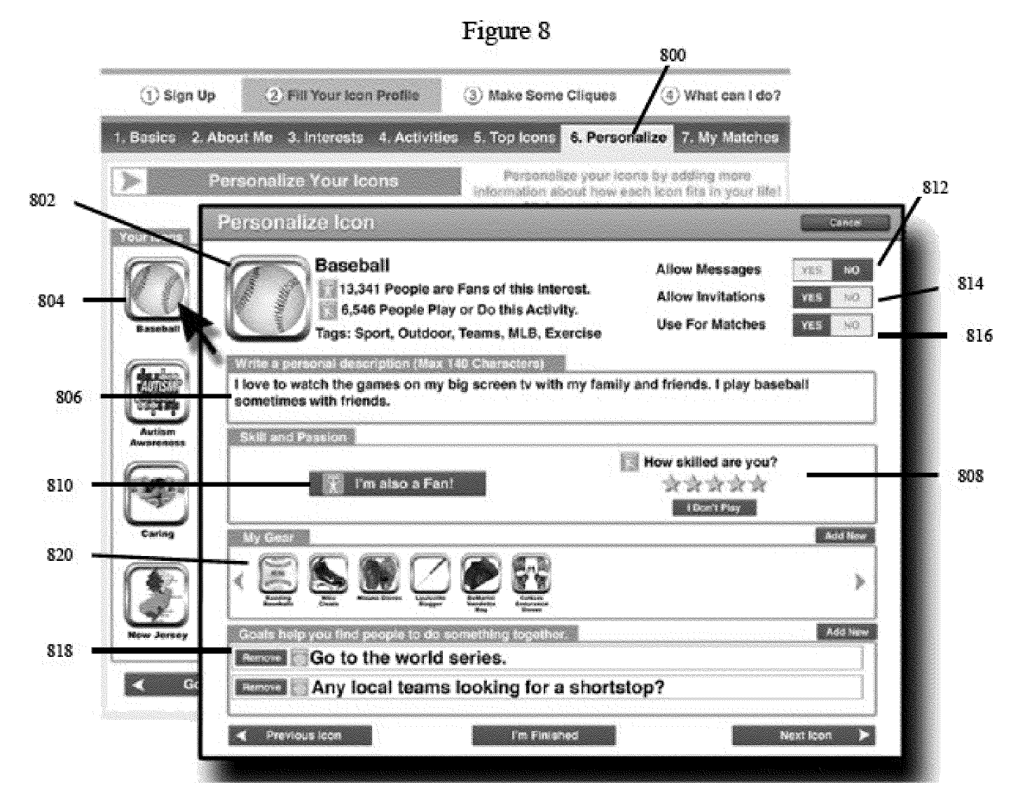

FIG. 8 illustrates an exemplary interface of an icon-based social network system displaying a personalized icon including user preferences and secondary descriptors associated with the icon, according to embodiments of the present invention. In the example shown in FIG. 8, the personalized icon 802 may be generated according to exemplary method 700 which may be initiated by interacting with “Personalize” tab or button 800.

In an embodiment, the personalized icon includes user preferences and/or secondary descriptors, such as icon-related preferences, sub-icons (e.g., associated icons), goals, media, security preferences and further user or system customization. The user preferences and secondary descriptors allow the user to display further information in various forms in accordance with their preferences, dislikes and skills relating to a profile element which may appear as a pop up or other known or state of the art displaying techniques when that icon is selected. This information is helpful to a viewer of a profile in determining a match or for learning more about a user's icon data box. Users may also select general or specific concierge or advertising preferences associated with each icon element and secondary descriptor such as a brand preference. This information is also utilized by the search engine for more precise matching, for community features and concierge and advertising services.

In this example, the user selects a baseball icon 804 for personalization. In the icon header, the user may view the total approximate number of fans and players of the baseball icon within the icon system. It is noted that this number may be filtered based on the selected zone and user compatibility matching. In the icon header, one or more tags may be shown which indicate other search terms related to baseball that is considered. Other tags relating to personality traits typically associated with baseball players may be listed such as patriotic, patient and dependable.

As shown in FIG. 8, the customized icon includes a text-based personal preference description 806. This text may appear as a pop up or second layer of information from a selected icon of interest. The customized icon may also include a skill and passion rating 808 and a related status (e.g., Fan status) 810.

In an embodiment, one or more user preferences associated with the selected icon may be set by the user, such as, for example, whether the user allows wishes to use join associated icon communities relating to that icon, allows messages associated with the icon 812, whether the user allows invitations associated with the icon 814, and/or whether the personalized icon may be used by the icon system for matching purposes 816.

In an embodiment, one or more user goals 818 related to the selected baseball icon may be set by the user, which, for example, may assist in more precise matching and with concierge and advertising services. In an embodiment, the icon-related goals may be shown in a goal summary feed or in an icon pop up. The icon-related goals may also allow the user to track progress of his or her achievements over time.

In an embodiment, the user may associate one or more favorite brands, gear, equipment, or the like (in the exemplary “My Gear” section 820) with the personalized icon. The “gear” information may be used as a means to provide advertising targets, data, and improve advertising results for the user and advertiser. Users may potentially select form pallets of “official” advertiser brand icons which customized functionality or create their own. In an embodiment, via the described icon profile creator system, a user may routinely and dynamically update, alter and change his or her profile icons based on their past activity schedule, seasonality, evolving preferences, location, and changing lifestyle. Notifications of these icon profile changes or status changes may be pushed to friends or into the general icon news feed.

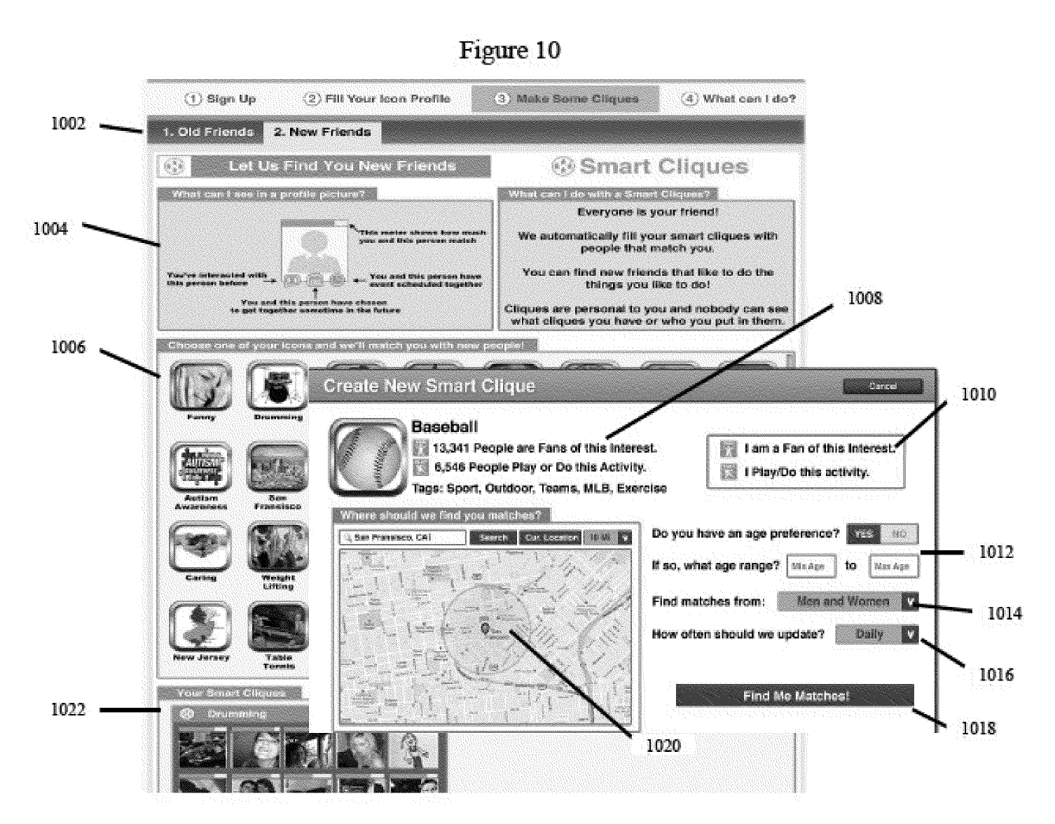

FIG. 10 illustrates an exemplary interface of an icon-based social network system displaying an exemplary “smart clique” compatibility matching system and user group creator tool, according to embodiments of the present invention. As shown in FIG. 10, the icon system is configured to perform “clique” matching and grouping. In the example shown, a user may initiate the clique generation process by interacting with the “New Friends” section 1002 within the “Make Some Cliques” tab. In an embodiment, the icon system may provide a general description or tutorial 1004 describing the indicators (e.g., overall compatibility, previous and future interactions and the like) associated with another user's profile to assist a user in the clique generation process. In an embodiment, the user may select one or more icons or keywords 1006 for use in matching within a particular community. In this example, the user indicates that he or she wishes to form a clique within the “baseball” icon community 1008.

In an embodiment, the user may select clique matching preferences such as a type 1010 (e.g., a fan, a player, etc.) that he or she wishes to use to identify potential clique matches. In an embodiment, the user may indicate an age range preference 1012, a gender preference 1014, and an update frequency preference 1016. In the header of the icon, one or more tags and/or keywords associated with the profile element may be listed.

In an embodiment, the user may select a preferred geographic zone or zones 1020 for the icon-based community. Smart Clique results may also factor overall icon and other compatibility in addition to system or user selected search preferences. The smart clique matching system is also utilized in the social communities and technologies. After results are posted, the user may save the search preferences and or individual members in their smart clique groups, such as the saved smart clique associated with a “drumming” icon community 1022. The cliques allow faster and more discrete communication for an icon activity or other grouping. In addition, cliques may also receive prioritized community interaction and communication with one another in the site.

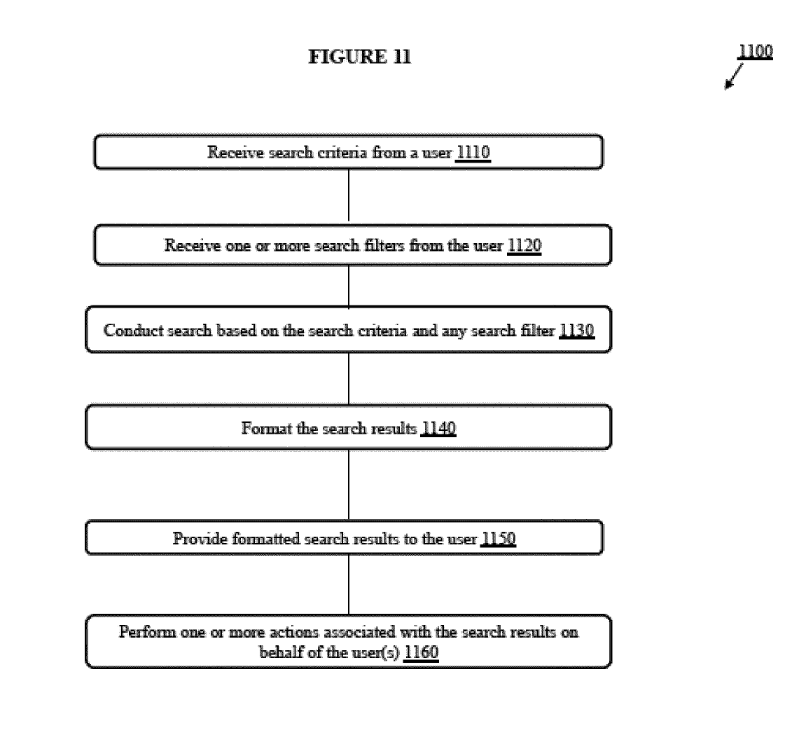

FIG. 11 illustrates an exemplary method 1100 for searching within the icon system, according to embodiments of the present invention. As described above, the icon system maintains multiple user profiles in an icon database. Each of the user profiles includes various data and information that may be used to identify the user profile during a search, the information including, but not limited to, the user-selected icons, search terms, associated icon data (e.g., secondary descriptors), and user preferences. In an embodiment, the user profile information and data is used to compare multiple user profiles and/or compare the user profiles with search criteria provided by or to the icon system. Advantageously, according to embodiments of the present invention, the uniformity in the user profile creation process, described above, optimizes the user profile searching mechanism and accuracy of the identified search results.

These primary and secondary icons and text box descriptors may be associated with a search term or terms for use with the search system. Viewing the associated search term or text descriptor when selecting an icon helps users select the icon that best describes each personality or icon group trait. A user may be allowed to add brief clarification text and/or secondary icons to further describe that interest or preferences within that interest. Other associated media and information may also be included and viewed by the searcher. These secondary user keywords may be used in search and matching algorithms. These icons may also provide a brief description of their meaning for other users viewing the icon, which may be displayed by pressing the icon or by a text descriptor below the icon which may also be the keyword search term.

In some cases the matching system or searcher may utilize a higher category topic or complimentary topic or interest in order to match other users and groups. For example, a drummer may have a search tag of “musician,” or “rock musician.” Matching a drummer to a guitarist might be the user's preference to play in a band together. In another matching algorithm example, a drummer icon may also be tagged as “outgoing,” a “performer,” and “artistic,” as secondary traits for a romantic match to someone who selected those personality traits for their profile match preferences. Users may also select from a pallet of secondary traits related to the hobby or interest that best describes them. Each hobby or interest may have these secondary traits assigned for matching to others based on a user's top interests and hobbies or the like. One having ordinary skill in the art will appreciate that various other similar matching techniques and methods may be employed.

In another embodiment, a user's profile elements, either individually, grouped or in combination, are compared to other users profile elements to determine a significant repeated occurrence of associations between icon profile elements, whereby the system may determine and suggest these other related or “missing” system icon element activities, hobbies, interests, and the like. The icon element suggestions may be search or posted and based on common user icon profile element trends and associations and other associative element preference theories. In a basic exemplary process example, four users are determined to have 8 common icon elements collectively; user five has 5 of these common icon elements. The system stores and posts a recommendation of the 3 missing new icon elements to use five.

The exemplary search method 1100 is initiated by a user. In block 1110, the icon system receives search criteria from the user. The search criteria may be any information that may be used by the icon system to identify other user profiles, including, but not limited to, one or more icons, one or more icon category/groups, one or more calendar events, users in community technologies, community types or genres, one or more keywords, one or more tags, one or more secondary descriptors, one or more user preferences, and any combination of multiple search criteria elements. In block 1110, the search criteria may be received from a user in multiple different ways, such as, for example, by conducting an icon-based search [e.g., a search of a community associated with a particular icon (i.e., an icon community)], by conducting an calendar-based search, by conducting a clique or group-based search, by conducting a geographic or map-based search, a community search and the like. For example, the user may conduct a search based on a baseball icon together with her preference for a certain skill or passion level for playing baseball an activity which may be shown with an icon.

In block 1120, the icon system may receive one or more search filters from the user. The search filters may be used by the user to further specify, define, narrow, and/or focus a particular search. Exemplary search filters may include, but are not limited to, a smart-clique filter, additional search criteria, a “zone” or geographic limiter, a social community filter, an icon filter, a secondary descriptor filter, a user preference filter, and the like. One having ordinary skill in the art will appreciate that in certain instances, block 1120 is optional, in that a user may not identify any search filters. It is noted that the user may customize and tailor a search using various combinations of search criteria and search filters to identify search results having a desired level of granularity.

In block 1130, the icon system conducts a search of the icon database based on the search criteria and any applicable search filter(s) to identify a set of search results. In embodiments of the present invention, any suitable searching algorithm may be employed in order to identify and or locate, and individually or mutually tag one or more user profiles matching the selected search criteria and applicable search filter(s).

In block 1140, the icon system formats the search results in accordance with search result display parameters. In an embodiment, the search result display may be in any suitable format including, for example, a map-based view, a list-based view, a social community view, a calendar-based view, etc., a report including compatibility results (e.g., user profile compatibility scores, assessments, calendar compatibility scores) a result acceptance option, a common or related icon list (e.g., a list of icons shared by the first user and the one or more user profiles identified by the search), a ranked list of the user profiles in the search results based on one or more of the compatibility results, a presentation of the search results including indicators identifying particular characteristics of the search results (e.g., an indicator identifying a common “high priority” icon match, a common status match, a “high/highest compatibility” match, a common friend/group/clique match), a comparison of secondary descriptors, etc.

In an embodiment, the user may select one or more preferred formats for the search results. Alternatively, if the user does not specify a preferred search result display parameter, the icon system may use a default view or display format. Compatibility results may appear when causally viewing users' profiles as previously described. In an embodiment, the user profiles identified in the search results may be scored and aggregated into a ranked icon-based result listing or these matched users may be aggregated into social environments. In an embodiment, the icon system may determine a compatibility score based on a combination of all of the search criteria elements entered by the first user (e.g., the searched icon(s), secondary descriptors, user preferences, etc.) to determine an overall compatibility score.

In block 1150, the formatted search results are provided to the first user. Following provisioning of the search results to the user, the icon system may perform various actions associated with the search results based on instructions received from the user, in block 1160. In an embodiment, in block 1160, the first user may view a full user profile of any of the user profiles identified in the search results (e.g., by touching or clicking on the desired user profile). In block 1160, the icon system may transmit a communication (e.g., e-mail, chat request) or an invitation type (e.g., an icon-based invitation, an event-specific invitation, a community invitation, a group invitation), a general connection request (e.g., a request from a user to connect with another user) from the user viewing the search results (i.e., the searcher) to one or more of the users identified in the search results. In addition, in block 1160, the icon system is configured to perform actions on behalf of the one or more users (e.g., the searcher and the users identified in the search results) such as, for example, receiving the communication and the searcher, such as, for example, performing an instruction to accept or modify an invitation, add invitation data to the calendars of the users, join the selected community, processing payment for any fee-based transaction (e.g., a concierge service), generating any reminders associated with an invitation, process any feedback associated with the communication, interaction, transaction between the users and add the feedback to the applicable user profiles, etc., and executing a request from the searcher to add one or more users identified in the search results to a custom clique or confirm certain smart clique matches.

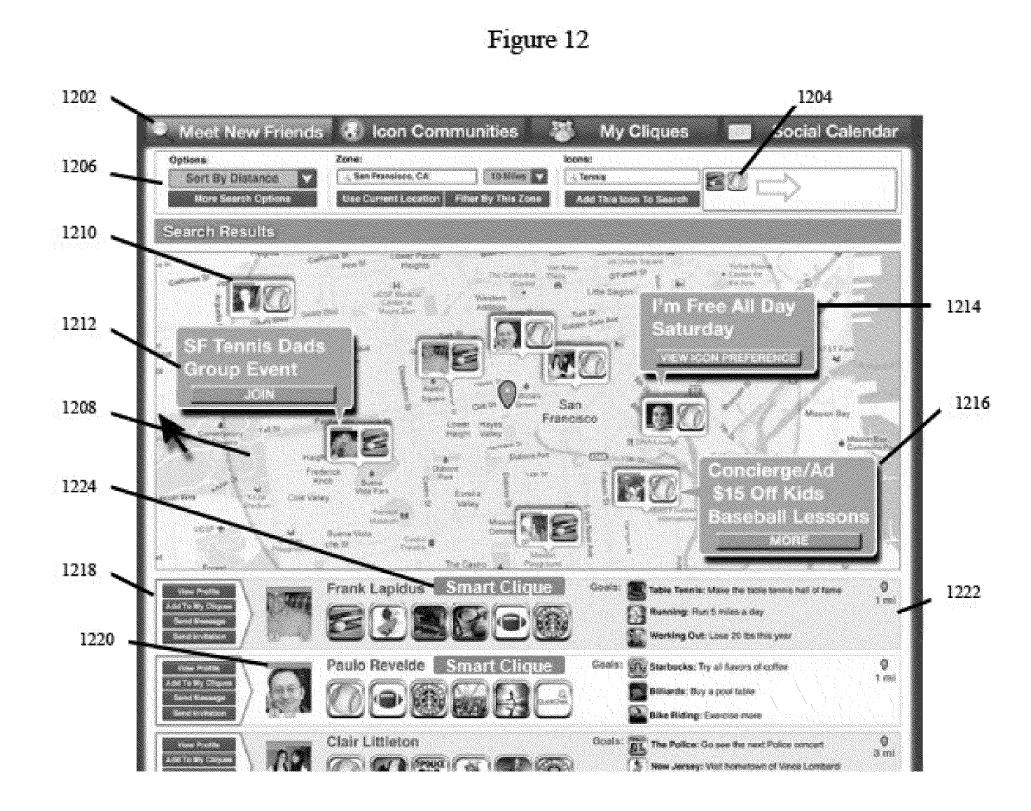

FIGS. 12-16 illustrate exemplary interfaces of the icon system displaying exemplary search results and associated user actions relating to the search results, according to embodiments of the present invention.

FIG. 12 illustrates an example of a search performed by the icon system, according to embodiments of the present invention. In the example shown in FIG. 12, a user initiates a search in the “Meet New Friends” environment 1202 of the icon system. The icon system receives the search criteria including icons 1204 (e.g., a baseball icon and a tennis icon) and a search filter 1206 including a geographic limiter or zone (e.g., a ten mile zone centered on San Francisco, Calif.). In an embodiment, a user may prefer to only input their street name, and not their exact address number, which would in turn display a general area on a map result. In another embodiment, during this process, a user may also search for matching and related concierge services, ads or deals, as described below.

In the example shown in FIG. 12, the search results are formatted and displayed in a map format including a map 1208 displaying the zone specified in the search filter 1206. The search results include a number of user profiles or advertisers matching the search criteria, such as the user profile/icon match 1210. In an embodiment, all or a portion of the user profiles or offers identified in the search results may be highlighted and/or displayed the map 1208. By pressing the highlighted icon, additional matching information and statistics may be provided.

In an embodiment, the user may click or otherwise interact with a match to view an associated pop up display 1212. Exemplary information that may be displayed by interacting with a match includes, but is not limited to, an invitation to join a group event 1212, an offer, an indication of a user's availability 1214 configured to optionally provide a brief comment regarding a calendar match or next availability, and an advertisement, promotion, or coupon associated with the search result.

In an embodiment, a user may post a similar invitation in their associated baseball or tennis icon online community blog which may post this event in an open invitations blog feed for others with related baseball or tennis icons including “fans” and “novice” subsets to view to attract more riders. This general structure and functionality may be used for any genre of icon posting.

In an embodiment, a listing 1218 of the user profiles identified in the search results is provided by the icon system. The icon system may be configured to highlight and list the best overall match icons based on estimated total compatibility and or by the user's selected search and compatibility preferences. In an embodiment, the listing 1218 may be prioritized to list the user profiles for users that are identified as members of a “Smart Clique” 1224 associated with the searcher. In an embodiment, a user profile may include a compatibility measure or score 1220 which visually indicates the degree of compatibility via a color-coded bar or other score indicator. In an embodiment, the listing 1218 may include a goals indication and/or description 1222 associated with one or more user profiles identified in the search results.

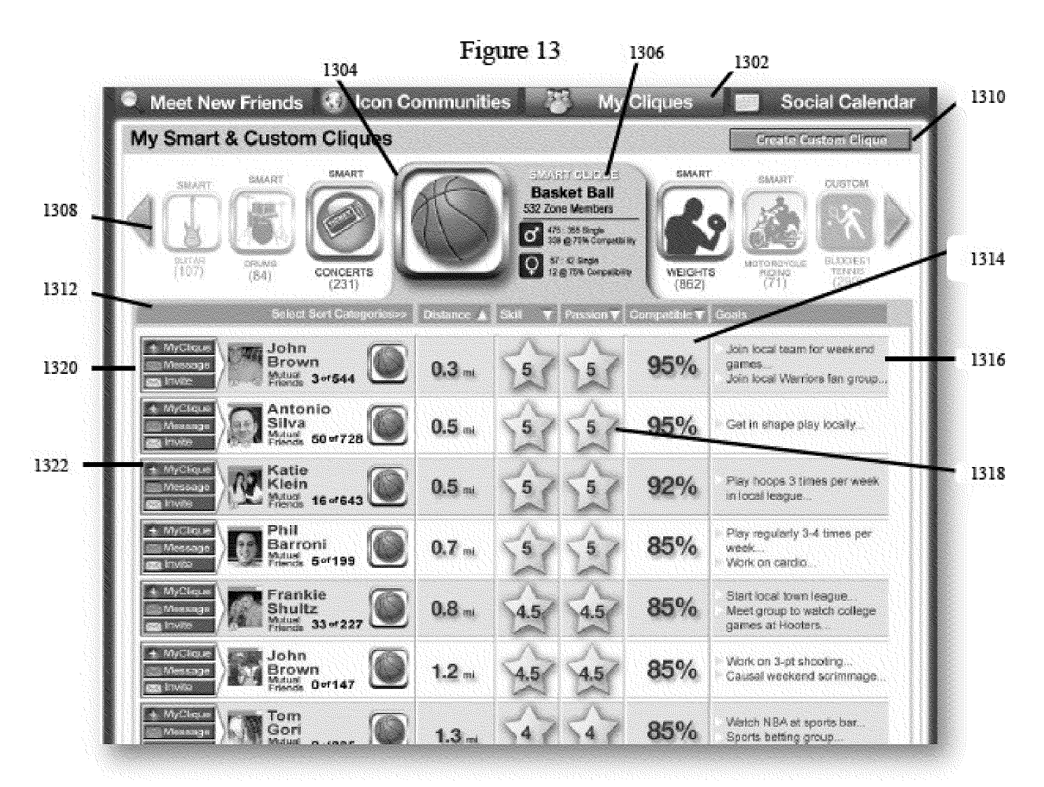

FIG. 13 illustrates an exemplary interface of the icon system displaying exemplary search results generated by the icon system, according to embodiments of the present invention. In FIG. 13, the exemplary search results page results from a search conducted within the “My Cliques” environment 1302 of the icon system. The exemplary user initiating the search is a member of a basketball icon-based smart clique 1304. In an embodiment, the basketball icon-based smart clique header 1306 includes various statistics associated with the clique. The exemplary user is also a member of a number of other smart and/or custom cliques, and may conduct a search for user profiles within any of the cliques or icon profile elements identified in the scrollable banner 1308 shown in FIG. 13.

In an embodiment, the user may create a custom clique 1310 including one or more of the user profiles identified in the search results, and the custom clique would be associated with the searcher's user profile and stored by the icon system.

As shown in FIG. 13, the search result listing may be sorted according to one or more criteria 1312 (e.g., by category, distance, skill indicator, passion indicator, compatibility, goals, etc.). In the exemplary search results listing, a number of different data points and information may be displayed to the searcher, including, for example, one or more compatibility scores 1314 associated with the user profiles identified in the search results, one or more goals associated with the icon activity and user 1316, a passion or skill level indicator 1318, and a geographic distance between a location associated with the user profiles identified in the search results.

As shown in FIG. 13, the searcher may take one or more actions with respect to a user profile identified in the search results, such as, for example, sending a message 1320 to a user associated with a user profile, inviting the user to a social environment, adding (or inviting a user to join) 1322 a “My Clique” associated with the searcher.

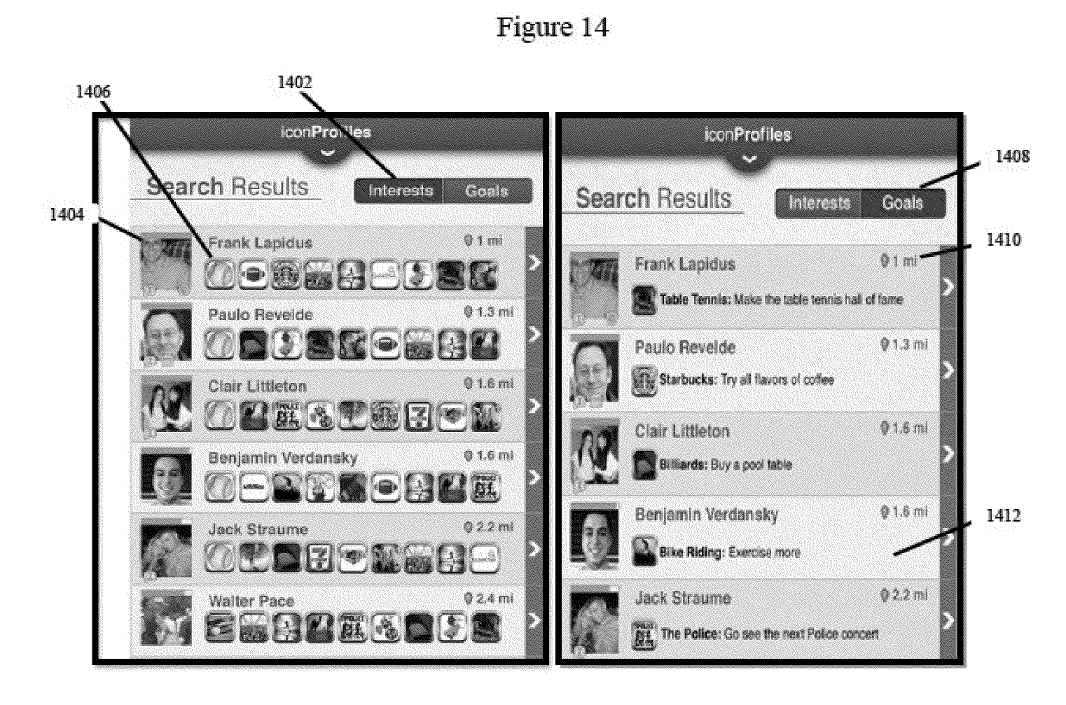

FIG. 14 illustrates exemplary interfaces formatted to mobile application-based embodiment displaying exemplary search results identified by the icon system in response to search criteria including one or more secondary descriptors, according to embodiments of the present invention. The exemplary interface on the left-hand side of FIG. 14 illustrates exemplary search results presented and sorted by the icon system in an interests-centric view 1402. As shown, each user profile 1404 is presented with a corresponding listing of his or her interests 1406 identified and displayed to the searcher. In an embodiment, as shown in FIG. 14, the search results may be presented and sorted by the icon system in a goals-centric view 1408. As shown, each user profile is presented with a corresponding listing of his or her goals 1412 identified and displayed to the searcher. In addition, a geographic proximity 1410 associated with each user profile may be indicated in the search results.

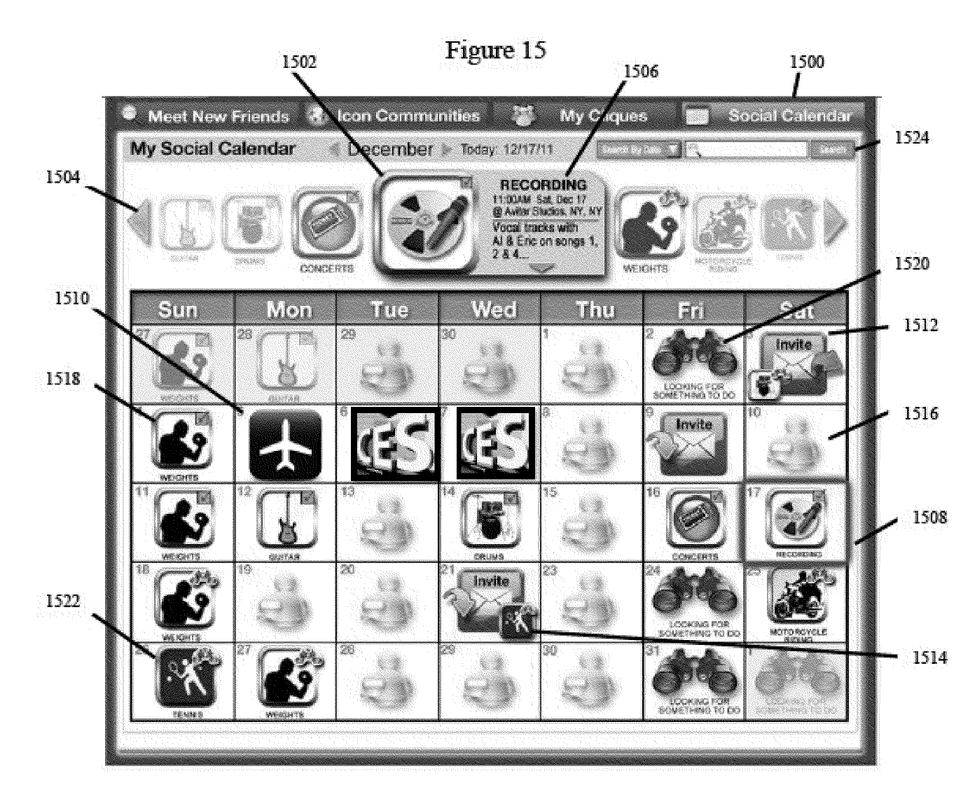

FIG. 15 illustrates an exemplary interface of an icon system displaying an exemplary icon system integrated interactive icon-based calendar 1500, according to embodiments of the present invention. The icon-based calendar 1500 provides an icon profile integrated image-based communication of scheduled events, availability for time slots/dates, and unavailable time slots/dates or private activities 1516 identified by a user and/or the icon system. According to embodiments of the present invention, the calendar 1500 may be used to view and create events, view and match open times, and/or view a new friend's potential availability and send an invitation based on that icon.

In an embodiment, a user may add a new calendar event to his or her calendar 1500 or review existing calendar events by selecting an icon (e.g., the music recording icon 1502) from a toolbar containing but not limited to the multiple icons elements 1504 from the user's profile. In this example, the user selects the music recording icon 1502 in order to highlight or identify any associated events on his or her calendar. The selected music recording icon 1502 includes a header or pop up identifying information 1506 relating to any calendared events and preferences associated with the selected icon. In addition, in this example, the corresponding event 1508 associated with the selected music recording icon is highlighted in the calendar.

In another embodiment, the icon system may generate the pop up associated with the music recording event 1502 in response to a user interact with the date on the calendar 1500 including the music recording event (e.g., December 17^{th}). In another embodiment, a current day may be automatically highlighted (e.g., when the current day is December 17^{th}) when the user opens the calendar and any associated events may be highlighted in a pop up window (e.g., the music recording related event 1502).

As shown, the calendar 1500 may include multiple icons and various indicators relating to the icons and events which may also be displayed on a user's main profile pop up. For example, airplane icon 1510 may indicate traveling days whereby the icon system may be configured to locate or notify new friends and activities in the city of travel or more precisely at or near the user's hotel.

In FIG. 15, exemplary calendar entry 1512 includes an outgoing invitation (i.e., an invitation sent by the user associated with the calendar) associated with a drumming activity (as indicated by the drumming icon in the lower left hand corner of the calendar entry) to another user (as indicated by the arrow indicator on the right hand side of the invitation icon).

In FIG. 15, exemplary calendar entry 1514 includes an incoming invitation (i.e., an invitation received by the user associated with the calendar) associated with a tennis-related activity (as indicated by the tennis icon in the lower right hand corner of the calendar entry) from another user (as indicated by the arrow indicator on the left hand side of the invitation).

In an embodiment, the calendar may also contain icons to represent scheduled events, such as a workout 1518 which is open to other's participation. By pressing or putting a mouse over icon 1518, a user may see additional secondary detail such as, for example, time, intensity, requirements, other participants, comments, and/or information associated with the workout routine. In an embodiment, the calendar may include an icon 1520 representing a day and/or time the user is available and actively looking for an activity to do with a friend.

Various other indicators may be used in connection with the calendar to communicate and represent information to one or more viewers of the calendar 1500, such as, for example, an icon/indicator indicating an open invitation that has not been accepted, an icon/indicator indicating an accepted group activity (e.g., a motorcycle ride on Saturday or registered “Fans” may attend the ride starting point, end point or take a ride as a passenger on the back of a motorcycle), a skill level associated with a calendared event (e.g., an indication of an “N” in proximity to an activity icon indicating that the user is a novice).

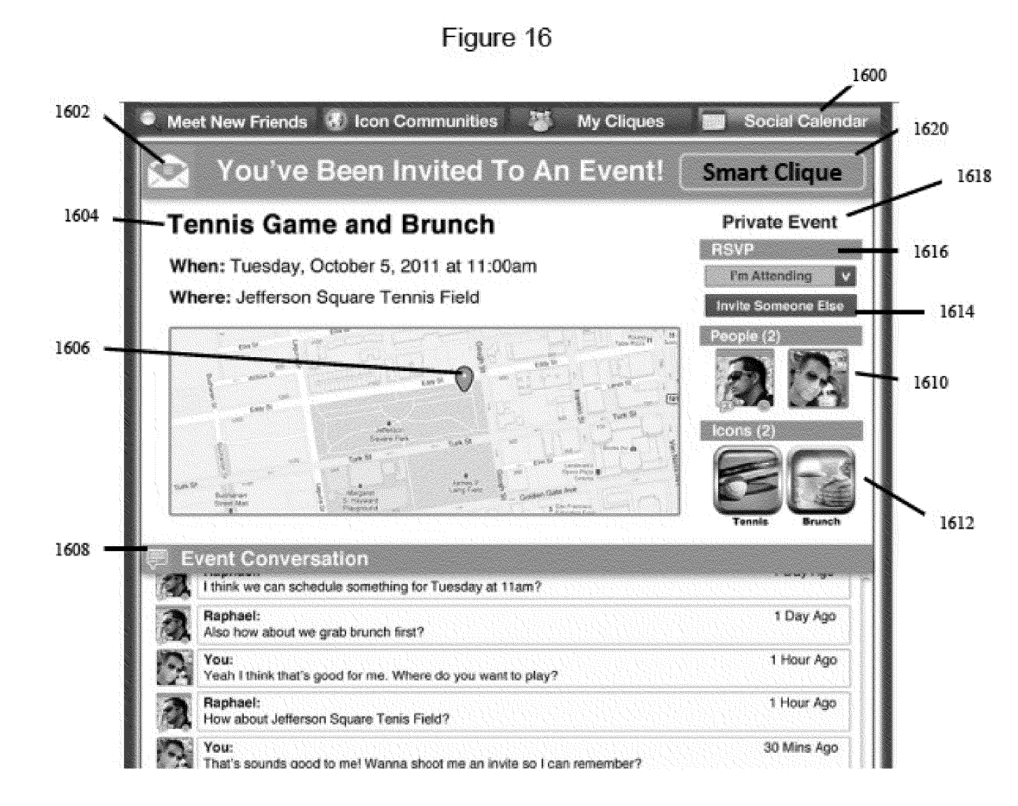

In the example shown in FIG. 15, the user may interact with an icon in the calendar to view additional information associated with the event and/or access additional functionality of the icon system. For example, if a user clicks on the tennis icon 1522, additional detail relating to the tennis event may be displayed to the user, such as the display shown in FIG. 16. As shown in FIG. 16, an exemplary interface of the icon system is provided which displays an exemplary invitation and chat associated with the tennis event, according to embodiments of the present invention.

In the example shown in FIG. 16, the invitation may be viewed with the calendar environment 1600 or system generated match result. As shown in FIG. 16, the exemplary invitation 1602 may include various event/invitation related information including, but not limited to, a name of the event 1604, time of the event, a link to the community event, and location of the event, a map identifying the event location 1606, a conversation or chat associated with the event 1608, an indication of the participants in the event 1610, one or more icons representing the type or nature of the event 1612 (e.g., the tennis icon and the brunch icon), an actionable link to invite one or more other users to the event 1614 or RSVP to the invitation 1616, and a privacy setting associated with the event 1618 (e.g., the indication that this is a “Private Event”). In an embodiment, an actionable button may be provided to allow the user to generate a “Smart Clique” 1620 based on the event. According to embodiments of the present invention, activities/interest may be best suited for one-on-one participation by the users or require a group or certain minimal level of participation which may be set as required or preferred criteria for a group event or invitation. For example, group activities requiring 3 or more users may include motorcycle riding, playing basketball game, or a hiking trip. In an embodiment, the minimum level of participants may be a requirement for the activity to commence. Calendar activities, invitations and events may also be associated with the social communities.

Embodiments of the present invention also offer a calendar feature button that determines and presents schedule conflicts by showing a green or red indicator, for example. A user may open a calendar to view potential conflicts or an icon indicator may provide a free or booked indicator for that time slot. Once accepted, the icon activity is added to the user's calendar publicly or privately and in some cases the user may suggest and forward the activity or event to their friends or others. In an embodiment, a referral icon (not shown) may contain written or unique icon-based recommendations to increase site usage or refer a friend to also participate in the event. Users may view a public version of another user's calendar in order to select a date and time for a suggested activity. Calendar activity may be tracked, displayed and aggregated and summarized for use by the users and system. Lastly, calendar functions may be used to attract specific advertising and concierge offers based on selected icon activities, zone and availability.

In embodiments, users may check into icon activities and events allowing other users to potentially locate and join them. According to an embodiment of the present invention, the icon system may create an activity history log and rating, with user comments and added media that may be viewed by the user or other members within the community. In an embodiment, users may earn status, icon badges, in-community status or perks for the number of check-ins for their icon activities or for sending invitations to other members.

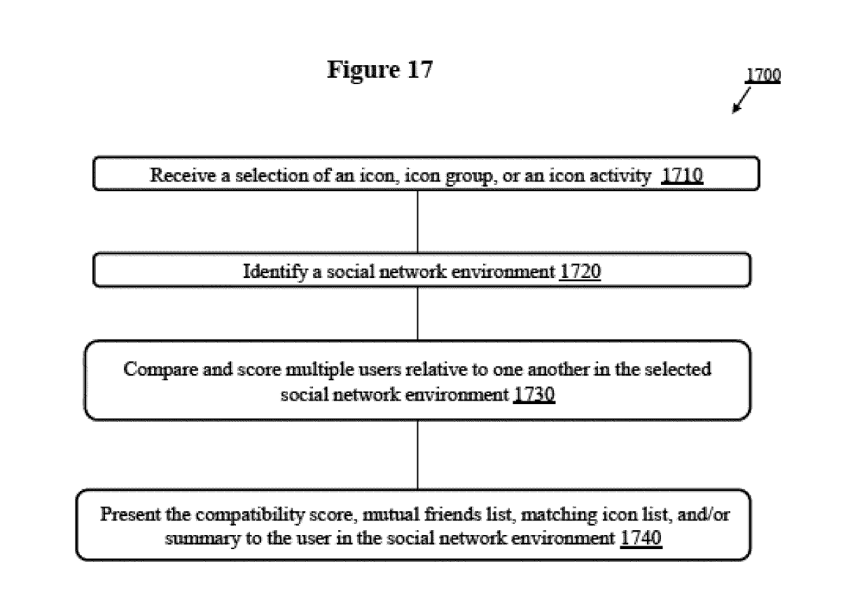

FIG. 17-19 illustrates an exemplary method 1700 for using a generated icon-based user profile system in multiple social network environments and various social network technologies, according to embodiments of the present invention. In an embodiment, the icon system associates a user profile with one or more internal environments (i.e., environments within the icon system) and/or external social network environments (i.e., third party web services and/or applications). In an embodiment, the association and/or integration of the user profile with the one or more environments may be based on the user profile's icon community preferences, smart clique preferences, matching criteria and/or preferences, or the user's zone preferences. In an embodiment, the icons and associated information (e.g., secondary descriptors and user preferences) of a user profile may be used to determine compatibility of the user with other user's in the different environments.

According to an exemplary method 1700, the icon system receives a user selection including an icon of interest, an icon group, an icon activity, or the like, in block 1710. In block 1720, the icon system identifies a social network environment type with which the user wishes to have his or her user profile integrated/associated. Exemplary social network environment types according to embodiments of the present invention include, but are not limited to, a text-based blog or chat, a forum, a video chat or conference, a video or movie viewing platform, a marketplace, a social gaming platform, a location-based or local event platform, etc. It is to be appreciated that the social network environments may be a part of the icon system (i.e., internal environments) or third-party administered services or applications (i.e., external environments accessible via an API). In an embodiment, the icon system may identify the social network environment type based on a selection received from the user or the icon system may determine or suggest a social network environment type that contains other users who have a high compatibility with the particular user. In an embodiment, other user with matching or related icons and icon groups may be aggregated by the icon system into a selected icon community.

In an embodiment, the user profile may be used to filter and prioritize the candidate social network environments for association with the user profile. For example, the user profile may include one or more user preferences relating to a desired community size, location, demographic, and those user preferences may be used to filter the candidate social network environments.

In block 1730, the icon system compares and scores the multiple users in a selected social network environment based on the user profiles associated with the multiple users. In an embodiment, the comparison performed by the icon system results in a determination of the mutual compatibility, online status, or location of the users within the community and associated compatibility scores are generated.

In block 1740, the icon system presents one or more of the generated compatibility scores, an environment summary, a matching summary, a mutual friends list, and/or a matching icon list to the one or more users in the social network environment. In an embodiment, a mutual compatibility score, or other indication may be displayed by the icon system to designate new highly-compatible users, previously confirmed smart clique members, or other previously identified friends. Mutual priority posting status or highlighting in an icon social forum or other community may be given to matched users.

According to embodiments of the present invention, certain social network environments (e.g., online gaming communities, video chat communities, etc.) may advantageously use the user profile to enhance the respective community experience and encourage socialization.

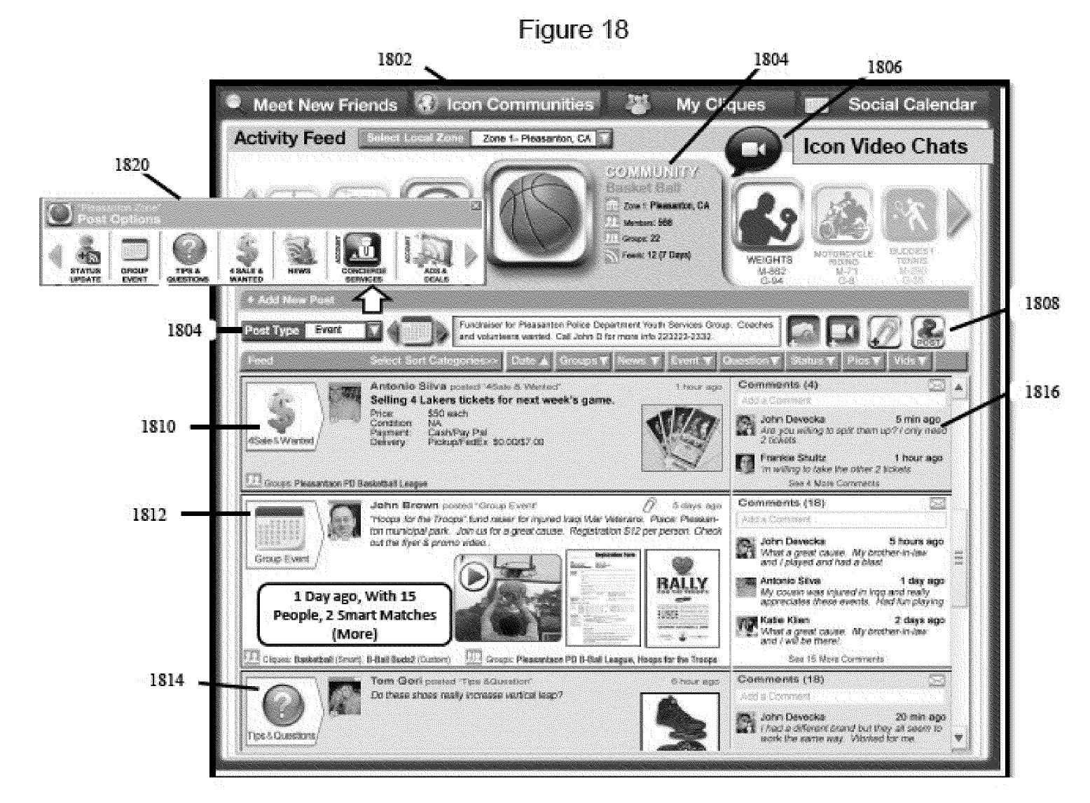

FIGS. 18-20 illustrate examples of the further integration and expandability of the icon profile system with various system and external social network environments having various associated technologies, according to an embodiment of the present invention. Previously described feature sets included various user, group and icon system directed searching and matching methods for user-to-user or group contact, potentially with the intent to email, chat, play, select to receive notifications of individual icon element updates, meet, share, or schedule and participate an activity together based on an Icon element or associated icon category.

By adapting the icon system within various social network environments, online social communities may include icon-based profiles and increase social connectivity in those communities. Therefore, embodiments of the present invention provide a suite of social network environments which display and are also linked to users' profile and profile elements and icon network system. Further, icon-connected and specific blogs and social forums offer a user an alternate method of being introduced, finding commonalities quickly, chatting, learning, and sharing information with a larger group of matched individuals. While in these communities, users' profiles may be compared and matched based on the icon element, compatibility, and/or other factors (e.g., a geographic zone). The icon based social network system in combination with these social environments allows users new ways to promote and maintain relationships with a larger collection of icon aggregated and matched users with important matching icon elements and interests.

In one embodiment, in the “icon communities” menu, the icon system offers a list of social network environments and technologies. After selection of the preferred social network environment, such as a blog, social forum, marketplace, video chat or billboard, the user may be offered a toolbar that allows instant community switching from one dedicated icon element or category type to another which may relate to and match some or all the icon elements in their icon profile that have an associated community environment feature.

In addition, the icon system capabilities provide further enhancements to these social network types which encourage previously unknown users to share information and identify, communicate with, and locate users and their publicly posted information in these communities who they are highly compatible based on factors beyond the unifying icon community element or elements, such as smart clique matches.

In an embodiment, the icon system compares user profile data in a community and provides a visible overall compatibility score or revealing abbreviated icon matching pallet to each user. While users of these communities have dynamic access and may visit and exit different suites in a single social community type, the icon system may score a user to the community who are currently in reachable attendance or those who have temporarily exited, and optionally suggest that the user visit certain locations where a highly compatible match, smart clique, friend, or other match is located.

In another method of the invention, users with matching commonalities, like a smart clique, may receive mutual priority features (e.g., placing a smart clique's blog posts in a higher priority compared to less compatible users or suggesting that a user visit a certain video chat room within a video chat service where a highly matched user is located). That user may be easily identified by an indicator and commonalities may easily be viewed which promotes new relationship formations. These virtual icon system introductions, notifications and placement techniques intend to create mutual connection opportunities for friendships based around common icon interests.

In embodiments of the present invention, use of the icon system and methods with these internal and external social network technologies greatly improves user-to-user connectivity when compared to systems allowing a user to review only another user's screen name or having to engage in the time-consuming task of reading verbose text-based static profile pages to determine possible commonalities.

FIG. 18 illustrates an exemplary interface of the icon system displaying an exemplary user-selected icon community type including an icon-themed social blog or forum based on one of their collectively matching icon profile elements. Potentially, each icon element a user selects for his or her user profile may be fully integrated throughout the icon system and may have an associated dedicated social community environment and social community. In an embodiment, the user may select an icon element selected to be the focus of the community activity and associated conversation/dialogue. A user may select from a toolbar including other icon element communities derived from the user's profile elements and preferences, according to embodiments of the present invention. In the dedicated icon community blog shown in FIG. 18, a user may access an icon community type via an “Icon Communities” tab 1802 or similar link provided by the icon system (e.g., a community blog focused on the icon element “basketball” which includes a user-selected zone preference).

In the example shown in FIG. 18, a user selects a community blog social network environment and subsequently selects a basketball icon community from the icon elements available in their icon element toolbar area 1804. The selected icon community statistics are also shown in 1804. A second social network environment shown is a quick enter button for a video and text chat environment for basketball relating to that community 1806 and a blog or /bulletin board feed 1808. Many options exist for the user to adjust the social network environments aggregation methods including zone selection and compatibly requirements.

In an embodiment, the icon community blog/bulletin board feed 1808 may be sorted by the user in order to immediately find desired specific category subject matter pertaining to their basketball interest and may include concierge service-related postings 1810, a calendar group event posting 1812, a section relating to tips and questions 1814 associated with this icon community, and comments 1816 associated with the icon community bulletin board feed.1808. Users are encouraged to post blog information under one of these provided category types. As shown, the user may select a desire post type for inclusion in or filtering of the icon community chat/bulletin board feed 1808 using a “post options” toolbar 1820. By selecting the right or left arrow on the icon community toolbar, new icon specific blog pages will appear. Advertisers and concierge service users may select to post ads, sale items and services in any of these community environments.

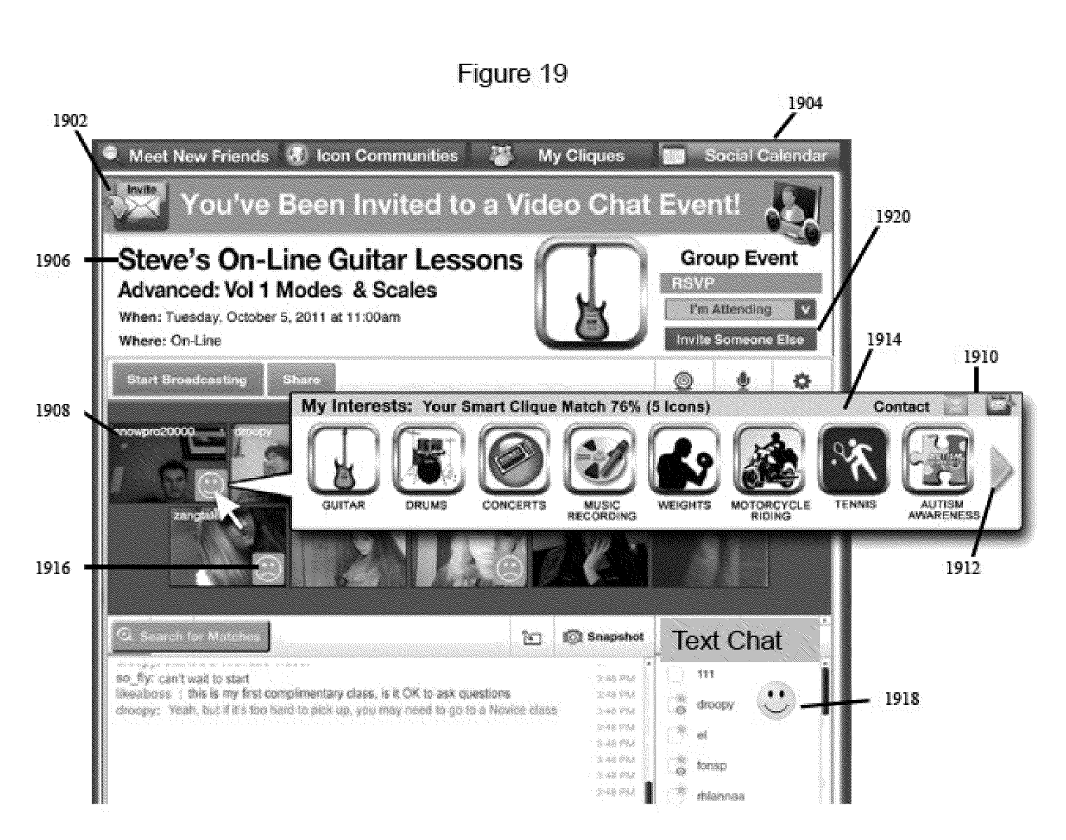

FIG. 19 illustrates an exemplary interface of an icon-based social network system displaying the integration and/or association of one or more user profiles and or icon element communities, in an exemplary video chat, text chat, video streaming, or video broadcasting environment, according to embodiments of the present invention. In an embodiment, the icon system may be configured to associate a user profile with a social network environment, such as the video chat environment shown in FIG. 19. As shown in FIG. 19, the video chat functionality may be accessed by a user via a related invitation 1902 which is accessible via the user's icon calendar suite 1904. The video chat may include a header or profile icon element linked to the event displaying information about the subject of the video chat or broadcast 1906 and other associated information including profile information of the chat host or leaders (e.g., the date and time of a schedule video chat).

Profile images associated with users participating in the video chat may be displayed in section 1908 including an indicator by each matching or related icon. Advantageously, a user may interact with any of the profile images to view all or a portion of the participants' user profile 1910. The icon profile system advantageously allows members to efficiently assess fellow participant's personal information and commonalities while maintaining participation in the event. The user profile pop up window/display example 1910 may include a scrollable list of the icons 1912 in the user profile. The user profile pop up window/display may also a banner 1914 having additional information relating to the user profile, such as, for example, a compatibility score, a link or means for further out-of-community communication with user (e.g., an e-mail link or other contact connection), etc. In an example, like a smart clique score, an “emotion” icon 1916 may be used to graphically communicate whether the other participant has a high compatibility with the user (e.g., a smiling face icon represents a positive match while a frowning face icon indicates a low compatibility score). The “smile face” compatibility score will prompt users to further explore mutual compatibility and immediately open up subject matter to initiate an interaction and bond. Many compatibility techniques as previously described in the user to user search system may be unitized within these social network environments. A user may join a video or text chat room associated by selecting one of their icon profile elements.

In an embodiment, the video chat may have an associated text-based chat forum 1918 and similar compatibility indicators. In addition, the video chat may include a link which allows a user to invite additional users and smart cliques to join the video chat 1920. Users may be guided to chat rooms based on the number of high capability users or user selected “matching” preference in that location.

In an embodiment, the exemplary invitation and video chat shown in FIG. 19 may be provided to a user for a fee in connection with the concierge services provided by the icon system. For example, the concierge services may be configured to send personalized business-related offers to a user or users and or gain additional access to tools and data to further sort user data to improve their advertising effectiveness. For example, if a user profile includes an electric guitar icon and displays a two star self-rating and the word “electric” in the description of the icon or a similar low skill rating indicator and a high passion indicator, a local guitar instructor may propose an online guitar lesson offer and send the user the invitation 1902 shown in FIG. 19. In so doing, the concierge (e.g., the guitar instructor) may utilize any additional secondary descriptor information in providing the offer, including but not limited to, a user's recent frequency of use or a rating of the music and guitar icon communities, forums and events.

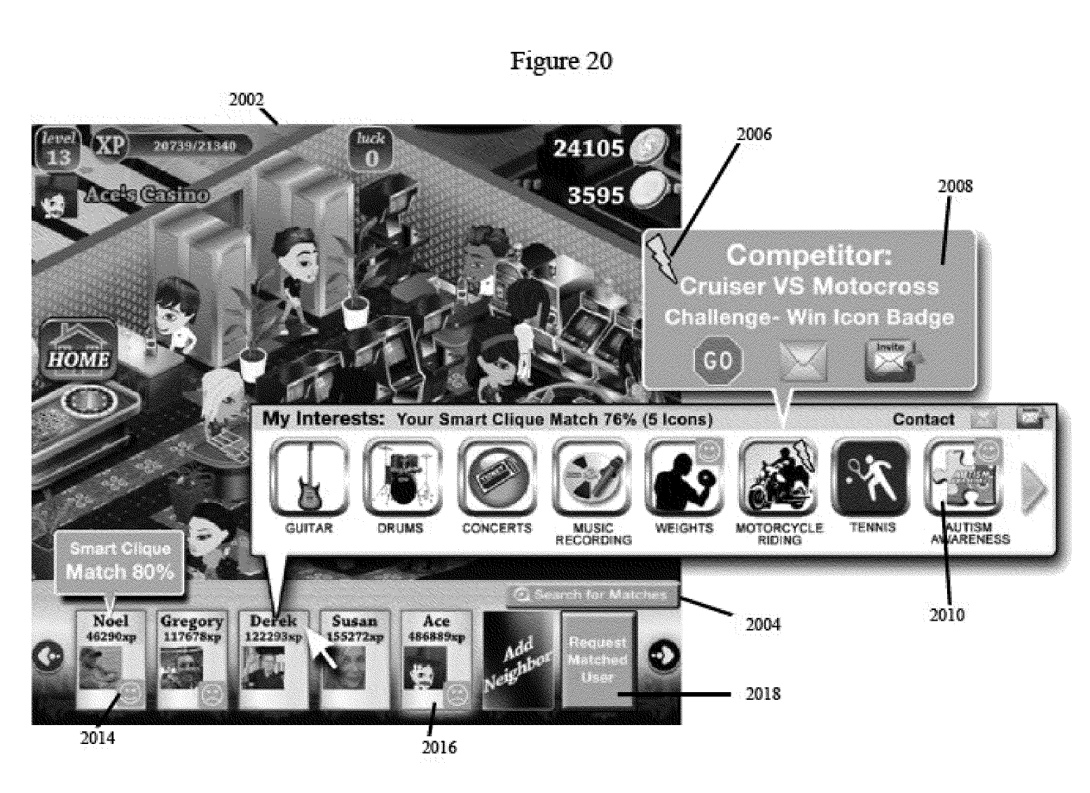

FIG. 20 illustrates an exemplary interface of the icon system displaying the integration and/or association of a user profile in an exemplary social gaming environment, according to embodiments of the present invention. As shown in FIG. 20, a user profile system and data may be integrated into an internal and/or external social gaming environment 2002. In an embodiment, the social gaming environment 2002 includes multiple icon system users and their associated user profiles and data.

In an embodiment, a user may interact with any of the user profile images shown in the bottom portion of the social gaming environment display in order to view or learn about the user's associated user profile. In the example shown, the pointer is placed over the icon profile picture associated with “Derek”, and a corresponding pop up window/display is generated including the selected user's user profile and associated icons. In some gaming communities, user profiles and matching icons may be displayed to increase social connection and understanding. In other gaming applications and communities, user profiles and data may be integrated into the game experience, selection and grouping of players, gaming content selection and game play, for example.

As shown in the pop up window/display associated with Derek, a viewer may visually determine that he or she has a common autism awareness icon 2010 and weights icon, thereby providing a potential basis for a further relationship or connection with Derek. Players may further be matched by zone. By discovering each others' commonalties in a gaming environment, users may desire to socially connect in real life and schedule an activity via the icon system. In the match list section 2004, a viewer may also visually identify the users in the gaming environment with which they are compatible (as indicated by the smiling face icon 2014) and/or users in the gaming environment with which they are not compatible (as indicated by the smiling face icon 2016). In addition, the associated compatibility score associated with a user may also be displayed (e.g., the user “Noel” has an 80% compatibility score/rating relating to the viewer). In an embodiment, a user may interact with a “Request Matched User” icon 2018 in order to locate users based on their matching preference as generally described in the icon search system.

In an embodiment, the user profile within the gaming community may also contain many gaming-specific categories and icons as noted in gaming culture, such as, for example, favorite video games, genres, favorite gaming characters, high scores, gaming achievements, favorite gaming events, gaming groups, and other gaming genre preferences. Those data elements may also be integrated within the icon system compatibility matching for that environment. In addition, social gaming environments may also match players together based on icon compatibility and player matching preferences. In other applications, user profiles and data may be incorporated directly into game play and competition. Games may specifically be designed and presented to users based on their icon profile elements.

In this example, the icon system displays a section of a user's profile icons whereby certain game mechanics include profile analysis to encourage increased competition or cooperation potentially based on icon profile elements. In an embodiment, icon 2006 indicates there is a potential or existing competitive challenge based on a matched icon profile of motorcycle riding. The viewing user and Derek may have different and potentially “competitive” icons or sub-icons associated with motorcycle riding, as indicated in area 2008 (e.g., cruiser motorcycle riders vs. motocross riders). In this example, the viewing user may be highly passionate about cruiser-styled motorcycle riding and the other user (e.g., Derek) is highly passionate about motocross riding. For mobile users with existing profiles, games may be offered for in-person connections. In an embodiment, users may sync up with local members at a gathering, play trivia games based on a profile data or various compatibility algorithmic results may be offered including local matching of friends, business or those looking for relationships.

According to an embodiment of the present invention, users may initiate a trivia game, for example, provided by the icon system or an application based on their icons, user profile, and/or user preferences, whereby, users, friends or acquaintances may be challenged about trivia derived from theirs and others' unique user profile data. Scores, credits and awards may be given to determine who has the most knowledge about a person or may guess how compatible users are as determined by the system. In an example, the game may be played online, in a social community or in person and given as a challenge at a function or party via a mobile device. Any media from that event may be sent and stored for the participants to view or post to the community.

In an embodiment, scores or badges may be presented based on past competitive performance within one or more gaming environments. In an embodiment, players may also be linked together collectively as a group based on icon system-generated or user-generated created icons or icon associations or elements to compete or perform a task in order to win status points, status and/or perks for their association. For example, in college icon competitions, users with Stanford University icons may be challenged by users having Yale University icons.

In this example, the user may accept a challenge to compete against the other player by pressing the “Go” button. The challenge may be related to the actual icon interest such as a motorcycle race or be more associated with the theme and mechanics of the video game. The users may also communicate verbal challenges, comments and virtual bets to each other to enhance the competitive environment. These two users may later agree to an “actual” invitation to ride “real” motorcycles together based on the recognition of a real mutual interest provided by the novel system in this fantasy environment.

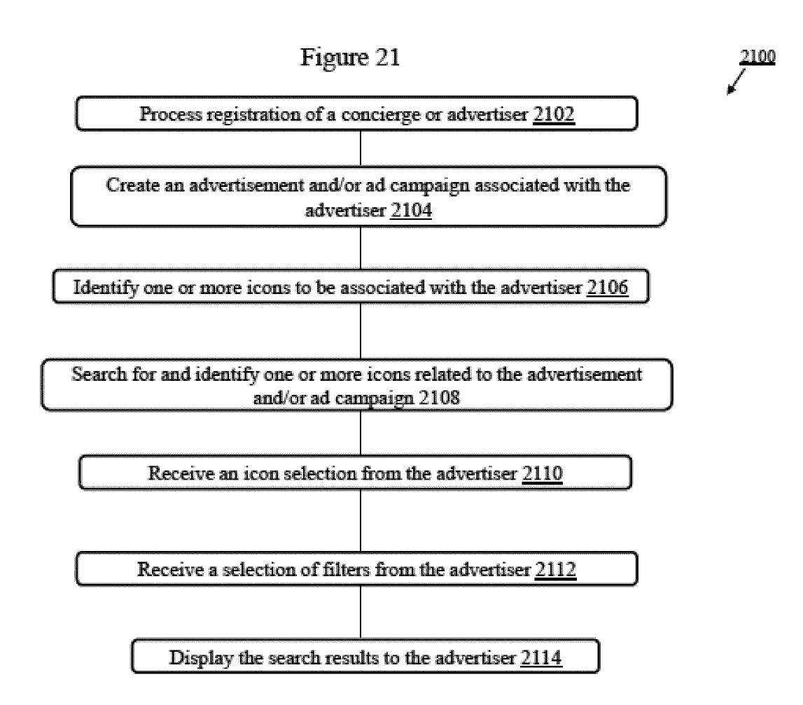

FIG. 21 illustrates an exemplary method 2100 for creating and/or delivering a concierge service or advertisement in the icon system, according to embodiments of the present invention. In block 2102, the icon system processes a registration of a concierge and/or an advertiser (collectively referred to as an “advertiser” in the description of FIG. 21). During the registration process, the advertiser may select one or more social network genres of interest (i.e., genres to which the advertisers wishes to direct advertisements).

In block 2104, the icon system receives information from the advertiser and creates an advertisement and/or advertisement campaign associated with the advertiser. In an embodiment, the advertisement, promotion, or service offer is created by the advertiser and posted and/or uploaded to the icon system. In another embodiment, the icon system provides the advertiser with a tool configured to enable the advertiser to create the advertisement with the icon system. The advertisement may be defined by various standard ad parameters including, but not limited to, any media type, design, description, format, and the like.

Using an advertisement search module of the icon system, the advertiser may select or be guided to one or more icons or categories of icons from the icon library with which the advertiser wishes to be associated. The selected icons may be used as a basis for directing one or more advertisements from the advertiser. In response, the icon system identifies the selected icon(s) and associates the selected icon(s) with the advertiser, in block 2106.

In block 2108, the icon system searches for and identifies one or more icons related to the advertisement and/or the ad campaign, and presents the identified icons to the advertiser. In block 2110, the icon system receives a selection of an icon from the advertiser and provides information relating to the selected icon to the advertiser (e.g., icon tags, icon description, icon statistics, user and geography statistics, icon keywords, etc.).

Optionally, in block 2122, the icon system may receive filtering information from the advertiser. For example, the filtering information may include, but is not limited to, secondary information or other filters such as one or more icons or sub-icons, icons, users who generally or specifically request ads or concierge services, a geographic zone, a status (e.g., “Player”, “Fan”, etc.), a skill level, a passion level, one or more goals, an advertiser, calendar events, branding information such as “my gear” or “my equipment”, and user preferences (e.g., any user preference associated with accepting advertisements and/or concierge services).

In block 2114, the icon system displays the search results including one or more user profiles, icons, icon communities, cliques, events, and the like to the advertiser. According to embodiments of the present invention, the advertiser may perform various actions with regard to the search results provided by the icon system. In an embodiment, the advertiser may select particular user profiles, social community environments, direct to user ads vs. public billboard ads, icon communities, events, and/or cliques to serve as recipients or intended targets of the advertisement and/or ad campaign. Optionally, the advertiser may eliminate or remove one or more of the elements included in the search results. In an embodiment, the advertiser may review one or more of the user profiles identified in the search results.

In block 2116, the icon system receives a selection of one or more advertisement placement parameters from the advertiser. The advertisement placement parameters define the specifics regarding the manner in which the advertiser wishes to distribute the advertisement (e.g., how, where, when, and to whom the advertisement should be distributed). Exemplary advertisement placement parameters include, but are not limited to, a placement method, a location, number of views or clicks on the ad, a distribution date, a campaign duration, one or more target user profiles, one or more target icon communities, one or more target genres, one or more target social network communities, and one or more target events. One having ordinary skill in the art will appreciate that other advertisement placement parameters may be used in accordance with embodiments of the present invention.

In an embodiment, the icon system may be configured to allow users to comment on and/or rate an advertisement, advertiser, and/or concierge service. In addition, in an embodiment, the advertiser may limit or receive a cost estimate, pay a fee and receive data, purchase orders and statistics regarding the effectiveness of the ad within the selected icon system.

According to an embodiment of the present invention, users may earn points, icon badges, status or credits for using or redeeming offers or for selecting official branded icons from the icon profile creator, for taking surveys or voting within the system or in other ways, possibly in lieu of paying a monthly fee for the service. As described above, advertisements, news and/or promotions may be placed on screens relating to a selected icon or group or community.

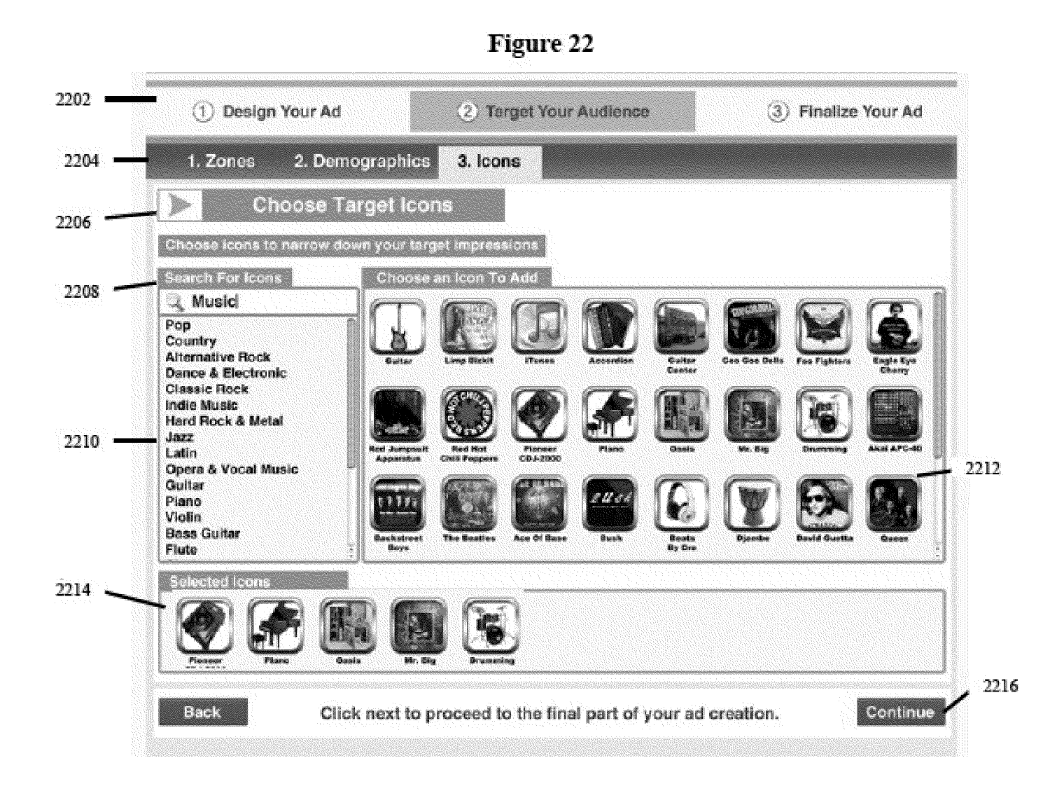

FIG. 22 illustrates an exemplary interface of the icon system displaying an exemplary advertisement creation and delivery tool 2202, according to embodiments of the present invention. As shown in FIG. 22, an advertiser may select one or more of a zone, demographics and/or target icons 2204 for use in connection with the creation and distribution of an advertisement and/or an ad campaign. In the example shown in FIG. 22, the advertiser is presented with the “Choose Target Icons” functionality 2206 for use in selecting one or more icons for use in targeting users of the icon system.

In an embodiment, the advertiser may select from and/or search for a number of icon categories 2208 associated with a genre. In this example, multiple musical genres 2210 are presented to the advertiser based on the advertiser's search for music-related icons. Upon a selection of a musical genre from the genre listing 2210, a pallet of related icons 2212 is presented to the advertiser. From the pallet of related icons 2212, the advertiser may choose one or more icons to add to the targeting criteria for the advertisement and/or ad campaign. The one or more icons selected by the advertiser are displayed in a “Selected Icons” 2214 portion of the display. Following selection of the icon selection as part of the targeting criteria process, the advertiser may click a “Continue” button 2216 to proceed with the advertisement creation method.

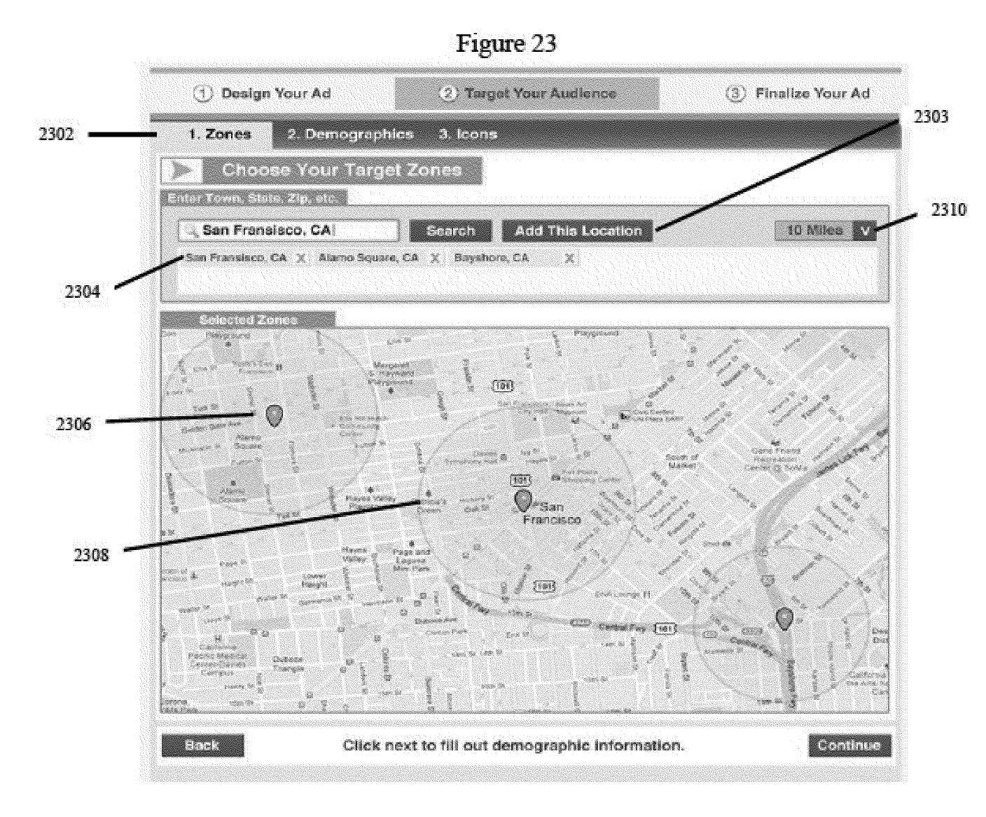

FIG. 23 illustrates an exemplary interface of the icon system displaying an exemplary advertising delivery tool, according to embodiments of the present invention. As shown in FIG. 23, the advertiser may select one or more zones (or geographic areas) 2302 as part of the targeting criteria for the advertisement and/or ad campaign by interacting with an actionable button, such as the “Add This Location” button 2303. In an embodiment, the advertiser may enter multiple zones in a selected zone field 2304 and/or on a corresponding map. As shown, a specified location may be identified by an indicator 2306 and a corresponding zone or region surrounding the specified location (e.g., zone 2308). In an embodiment, the advertiser may specify the size of the zone or region surrounding the specified location using, for example, the zone indicator drop down menu 2310.

According to embodiments of the present invention, users may proactively search for ads and concierge services based on their icon interest, via a concierge search system. Users may also indicate or push their level of interest in offers for each listed interest, brand, things, travel, or favorite activity which may include food and retail locations. In an embodiment, concierges, advertisements, or offers may be rated, ranked by and shared with other users. For example, highly-rated services, advertisements and/or offers may receive higher priority and more placement opportunities in the icon system.

In an embodiment, advertisements, coupons, offers, news and other promotions may be administered by the icon system or by a social network. In an example, a user may highlight his or her diving hobby icon as an “active interest” and identify secondary icons and tags for their certifications and completed dives. The user may add a new zone in the user profile prior to or after travel from Denver to Santa Monica and indicate an open calendar day for this coming Sunday morning. The local concierges and advertisers may be notified of a match via the icon system, calendar function or a post may be sent to the open diving community feed under open invitations by the diver. In this example, a concierge service vendor may then provide an offer in the available time slot. In an embodiment, the additional notification feature may be part of a premium account which may increase the monthly access fee for the concierge.

In another example, a user may select a “diving” icon as one of his or her top local traveling interests, thereby increasing the likelihood that a business would send a special concierge offer related to diving. In an embodiment, a user rating may be provided to concierges regarding the quality or frequency of acceptance of a user for posting active interests. In this example, the registered diving concierges or related advertisers may receive a message derived by a concierge search feature from this user requesting diving offers, or, alternatively, the user may proactively search a concierge database and select the best personality or secondary match, best rated or lowest cost dive master. In an embodiment, selection of a service provider may be strongly based on having strong commonality in other areas and user ratings.

In an embodiment, when a user views their profile, a highlight or indicator may be used to indicate an offer for diving has arrived with a pop up window or display, a revealing display tile, an inserted blog advertisement, an email or a text message including the details of the offer a credit card may be linked to the user account in order to hold or purchase a service or product offer by pressing a “book it” or purchase icon.

In another embodiment, for a fee, advertisers and brands may access a mass user system icon profile creator tool which allows upload or creation an officially branded icon for use within any user's profile. This special icon element type may contain unique functionality, secondary descriptor media, view and user tracking, offers, ads, and other like functionality.

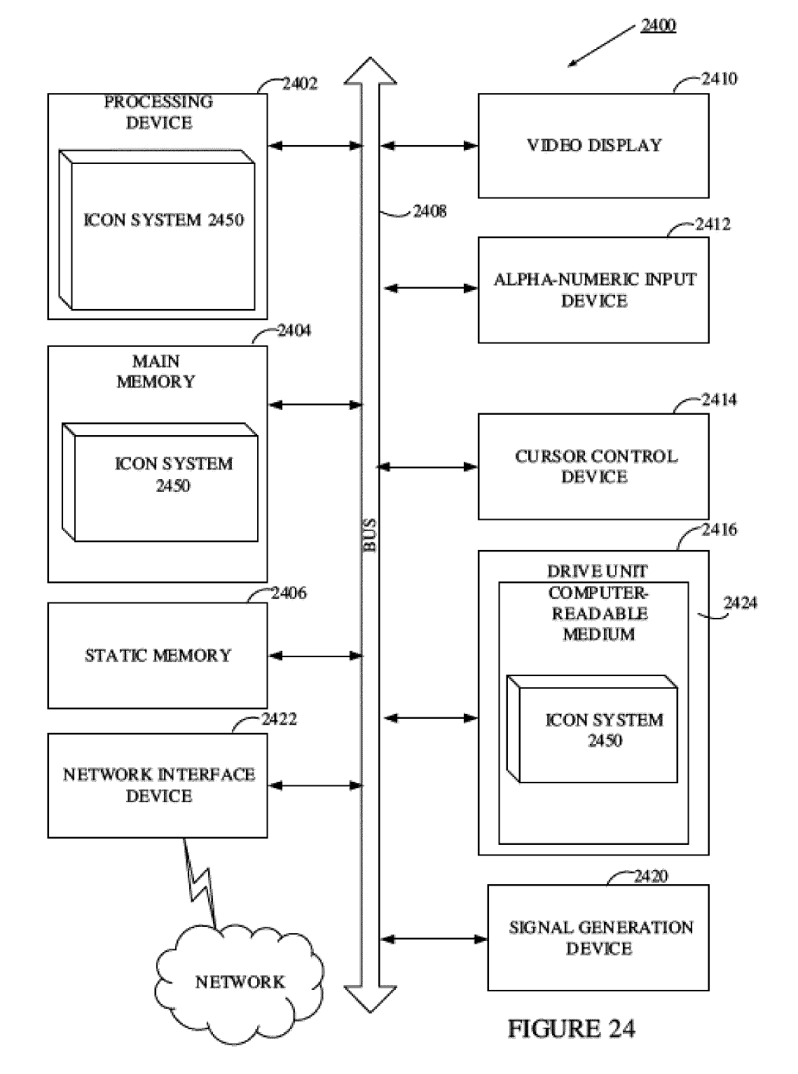

FIG. 24 illustrates a diagrammatic representation of a machine in the exemplary form of a computer system 2400 within which a set of instructions, for causing the machine to perform any one or more of the methodologies discussed herein, may be executed. In some embodiments, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 2400 includes a processing device (processor) 2402, a main memory 2404 (e.g., read-only memory (ROM), flash memory, dynamic random access memory (DRAM) such as synchronous DRAM (SDRAM)), a static memory 2406 (e.g., flash memory, static random access memory (SRAM)), and a data storage device 2416, which communicate with each other via a bus 2408.

Processing device 2402 represents one or more general-purpose processing devices such as a microprocessor, central processing unit, or the like. More particularly, the processing device 2402 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 2402 may also be one or more special-purpose processing devices such as an application specific integrated circuit (ASIC), a field programmable gate array (FPGA), a digital signal processor (DSP), network processor, or the like. An icon system 2450 may be provided which is configured to perform the steps, operations, instructions, and functions described in detail in the present application. The icon system 2450 may comprise processing device 102 configured to perform the operations and steps discussed herein.

The computer system 2400 may further include a network interface device 2422. The computer system 2400 also may include a video display unit 2410 (e.g., a liquid crystal display (LCD) or a cathode ray tube (CRT)), an alphanumeric input device 2412 (e.g., a keyboard), a cursor control device 2414 (e.g., a mouse), and a signal generation device 2420 (e.g., a speaker).

A drive unit 2416 may include a computer-readable medium 2424 on which is stored one or more sets of instructions (e.g., instructions of an icon system 2450) embodying any one or more of the methodologies or functions described herein.

In an embodiment, the icon system 2450 may be a software component (i.e., a set of instructions executable by a processing device of a computer system, such as a processing device) configured to perform the actions, functions, steps, processes, procedures, etc. described in detail in the present application.

The instructions of the icon system 2450 may also reside, completely or at least partially, within the main memory 2404 and/or within the processing device 2402 during execution thereof by the computer system 2400, the main memory 2404 and the processing device 2402 also constituting computer-readable media. The instructions of the icon system 2450 may further be transmitted or received over a network via the network interface device 2422.

While the computer-readable storage medium 2424 is shown in an exemplary embodiment to be a single medium, the term “computer-readable storage medium” should be taken to include a single non-transitory medium or multiple non-transitory media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that embodiments of the invention may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “maintaining”, “receiving”, “generating”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the invention also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method comprising:
receiving, by a processing device executing an advertising interface on a social network platform accessible by an advertiser, targeting criteria associated with an branded icon selected by the advertiser to identify targeted users registered with the social network platform to receive a customized advertisement directly from the advertiser via a user profile within the social network platform;
identifying, by the processing device, a set of targeted users that had a previous computer-based interaction with the branded icon via the social network platform, wherein the previous computer-based interaction with the branded icon is identified by the social network platform and stored in a data store of the social network platform; and
delivering, via the social network platform, the customized advertisement via a respective user interface associated with the set of targeted users.

2. The method of claim 1, wherein the targeting criteria identifies a zone selected by the advertiser, the zone defining a geographic area associated with the first set of targeted users.

3. The method of claim 2, further comprising:
calculating a fee associated with delivering the customized advertisement to the set of targeted users, wherein the fee is calculated based on at least a number of targeted users, the zone selected by the advertiser, and a duration associated with the customized advertisement;
providing, via the advertising interface, a method of payment to the advertiser for the customized advertisement; and
validating payment submitted by the advertiser.

4. The method of claim 1, wherein the advertiser generates the customized advertisement via the advertising interface of the social network platform.

5. The method of claim 4, wherein the advertising interface comprises an advertisement generation tool configured to receive advertisement parameters from the advertiser and generate the customized advertisement based on the advertisement parameters.

6. The method of claim 1, wherein the interaction with the branded icon comprises a selection of the branded icon by each of the set of targeted users to include the branded icon in a user profile.

7. The method of claim 6, wherein the interaction with the branded icon further comprises an indication of a user preference associated with the branded icon previously added to the user profile.

8. The method of claim 1, further comprising receiving, from the advertiser via the advertiser interface, a selection of an environment portal within the social network platform, wherein the targeted advertisement is delivered to the set of targeted users via the environment portal.

9. The method of claim 8, wherein the environment portal identifies a location within the social network platform comprises at least one of a news feed portal associated with the branded icon, a blog portal associated with the branded icon, a chat room portal associated with the branded icon, a video broadcasting portal, or an individual user profile portal.

10. The method of claim 1, further comprising receiving an advertisement placement parameter defining the delivery of the targeted advertisement to the set of targeted users.

11. The method of claim 10, wherein the advertisement placement parameter comprises at least one of a number of advertisement views associated with the advertisement, a distribution date, a duration of a campaign associated with the targeted advertisement.

12. The method of claim 1, further comprising providing a portal via the social network to a link to purchase a good or service associated with the customized advertisement.

13. The method of claim 1, further comprising receiving a rating of the customized advertisement from a first user of the set of targeted users.

14. The method of claim 1, further comprising receiving, from the advertiser via the advertisement interface of the social network platform, a request for statistics relating to a performance of the customized advertisement.

15. The method of claim 1, further comprising:
receiving, via the social network platform, search criteria from a second user;
identifying an association between the customized advertisement and the search criteria; and
distributing, via the social network platform, the customized advertisement to the second user.

16. The method of claim 1, wherein the previous computer-based interaction with the branded icon comprises a selection by a first user of the branded icon for inclusion in a user profile associated with the first user.

17. A method comprising:
providing, by a processing device, a plurality of users with an icon profile creator tool and icons to select one or more icons to establish an individual user-branded online icon profile comprising at least one branded icon and one preference for the branded icon;
storing the individual user branded online icon profile and other associated data in a searchable database;
providing a search portal to a third party user to identify a plurality of users having an individual user-branded online icon profile comprising a first branded icon related to a search term entered by the third party user;
presenting information associated with the identified plurality of users having the individual user branded online icon profile comprising the first branded icon;
providing an icon-based message creator tool to the third party to create a customized message with at least one branded icon to present to the identified one or more users;
providing a zone selector to receive a selection of a zone from the third party user, wherein the zone represents a geographic area associated with a first set of the plurality of users;
providing a fee generator tool to generate a unique fee for creating and distributing the customized message with the at least one branded icon;
distributing the customized message to the first set of the plurality of users; and
assessing the unique fee to the third party user.
